(19) United States
(12) Patent Application Publication
(10) Pub. No.: US 2022/0179887 A1
(43) Pub. Date: Jun. 9, 2022

(54) SYSTEMS AND METHODS FOR DISPLAYING AND USING DISCRETE MICRO-LOCATION IDENTIFIERS

(71) Applicant: WGRS Licensing Company, LLC, Newport Beach, CA (US)

(72) Inventors: S. Lee Hancock, Newport Beach, CA (US); Jordan T. Hastings, Newport Beach, CA (US)

(21) Appl. No.: 17/544,898

(22) Filed: Dec. 7, 2021

Related U.S. Application Data
(60) Provisional application No. 63/122,385, filed on Dec. 7, 2020.

(51) Int. Cl. G06F 16/29; G06F 16/2457

(52) U.S. Cl. CPC G06F 16/29; G06F 16/24573

(57) ABSTRACT

Systems and methods are provided for creating, curating, owning, controlling, and using extremely short alpha-numeric micro-location identifiers (MLIDs) relating to specific geographic areas for human to human, human to machine, and machine to machine input, communications, search, database and other geographic product and services for locations, small geographic areas, devices, keywords, products, and services. MLIDs provide extremely short, simple, and consistent discrete identifiers that can be used with AI-enabled devices and services by associating MLIDs with defined or undefined fixed, variable, and/or subjectively determined relevant subject areas (SAs).

### RELATED APPLICATION DATA

The present application claims benefit of co-pending U.S. provisional application Ser. No. 63/122,385, filed Dec. 7, 2020, the entire disclosure of which is expressly incorporated by reference herein.

### TECHNICAL FIELD

The present application relates to devices, systems, and methods for creating, curating, and using extremely short alpha-numeric micro location identifiers for human to human, human to machine, and machine to machine communications, maps, directions, deliveries, search, and analytics for locations, devices, keywords, products, and services related to discrete small, human-scale subject areas in and around places, properties, buildings, and other structures. The present application also relates to interpreting and resolving such micro location identifiers through artificial intelligence and other systems and methods and optimally displaying them on digital and printed maps and other viewable content and using micro location identifiers to expedite access to micro-location information, maps, products, and services.

### BACKGROUND

There are numerous methods of referencing locations, but they are typically long and cumbersome. Today there is no system that provides concise, discrete, universal micro location identifiers to reference micro locations (e.g., a door in a building, a tree in a field, a parking space in a parking lot). There is also 1) no current standard or unified method for referencing geographic locations digitally and 2) no unified geographic database, or “single source of truth”, for locations.

Today most micro location references by humans are colloquial and based on legacy street addresses and general word descriptions. Assuming a user can determine where they are, it is difficult to communicate that micro location to someone else or a machine. It is rare that humans communicate micro-locations with reference to latitude or longitude or any other global reference system. Various types of geographic references are used by humans, machines and computers for scientific, geographic information and database systems (GIS) purposes, global positioning systems (GPS), and other mapping, navigation, and geospatial communications services. These global geospatial reference systems (“Global Systems”) are typically global coordinate systems designed for the entire earth or other planetary or spatial body. For example, latitude/longitude (“Lat/Lon”) enables referencing any 2-dimensional location with a coordinate Lat/Lon pair. An example is 32 degrees, 47 minutes, and 38.1 seconds north latitude and 117 degrees, 21 minutes, 4.12 seconds west longitude, although there are numerous alternative formats for Lat/Lon and precise Lat/Lon references require additional references to a specific datum, or orientation of the coordinates to the planet. Other Global Systems that cover large areas are global grid systems such as Military Grid Reference System (“MGRS”), Universal Transverse Mercator (“UTM”), and in the United States, the U.S. National Grid (“USNG”).

The most common location referencing systems are based on legacy street addresses (“Legacy Street Addresses”) that vary in format and structure from country to country and even city to city within countries and are subject to numerous colloquial conventions and local knowledge. Further, these Legacy Street Addresses are not particularly well developed or curated in many parts of the world, and they rarely provide the level of precision provided by Global Systems. In addition to being long, cumbersome, and non-standard, Legacy Street Addresses are inadequate to provide the level of precision necessary for Micro Location (as defined below) referencing, mapping, navigation, information and data capture/usage, services, and communications. The terms Micro Location or Micro Locations refers to a precise location such as a point on the earth, in or near a building or other structure, door, parking space, seat at a table, or other location at a beach, in a parking lot, in a large room, etc. Micro Locations may also include a device, component of a building structure, and may also include small, designated areas such as parking spaces, rooms, loading docks, storage units, etc., whether fixed or moveable (e.g., an assigned area in a ship or other movable container).

Global Systems are all designed from to work from the top down, starting with a global sphere or other system that become more precise and granular as more granular referencing is added. Thus, to achieve 10-foot precision references with Lat/Lon, MGRS, UTM, USNG, etc. numerous digits are required. The smaller the area or location and the greater the desired precision, the more digits are required to reference under these Global Systems. As a practical matter, therefore, users rarely use Global Systems for Micro Location identification or referencing. Further, while these Global Systems work well enough when flying, driving, navigating, or location referencing for larger locations or determining proximity or bearing/directions ‘as the crow flies’ for cities, buildings, residences, street addresses, and other larger areas, these Global Systems are too long, cumbersome and inefficient to the point of being virtually worthless for everyday use by humans to identify, understand, reference, use and communicate Micro Locations. This is especially at the human-scale for 1 to 20 feet or in the immediate proximity of a person, for a small public space, in a specific office or room, or even locations in a restroom or closet. They are not much better to reference small areas (e.g., a tree, pothole, or parking exact parking space) within or near a building, yard, field, or similar Micro Locations or even larger office, residential, and other buildings, hotels.

The limitations of existing Global Systems and Legacy Street Addresses were not problematic when humans used them with pen and paper maps without digital devices, but they are inadequate and ineffective for human use with today's digital devices, visual displays, for computer and other device communications and/or navigation. The lack of a better system for identifying and communicating Micro Locations impedes the adoption and use of new technologies and devices, and there is a significant need for new robust, efficient, and precise digital infrastructure for real-time Micro Location (“RTML”) geospatial referencing and related information and services between humans and/or machines, as well as for RTML data and communications structures to capture, store, curate, manage and analyze Micro Location big data.

Over the past several years, there has been tremendous growth of new technologies and the number and capabilities devices for human, vehicle and other device assisted navigation and wayfinding, including autonomous vehicles (AV), artificial intelligence (AI), machine learning (ML), augmented reality (AR), virtual reality (VR), drones, robots, and other devices for transit, delivery, asset management, and similar systems (individually an “Autonomous Device” or “AD” and collectively “Autonomous Devices” or “ADs”). While the current Global Systems can be used by highly trained and skilled engineers, programmers, and operators and sophisticated devices and machines, they fail miserably in everyday human use and with voice and other human-machine interfaces for documents, emails, text messages, spreadsheets, database and other computer programs and documents.

There is currently no simple, short, and effective way to instantly identify, know, and communicate a Micro Location. Imagine the difficulty of a user responding to a question about where in the SoFi stadium parking lot they parked their car or the users wanting their food delivered with: “Oh, we parked at 117 degrees, 34 minutes, and 12.73 seconds west longitude and 33 degrees, 12 minutes, and 47.32 seconds north latitude”! Nor are there any better alternatives today enable short, simple, discrete, precise 2- or 3-dimensional Micro Location references available today. Humans are relegated to long, colloquial descriptions that are imprecise and ambiguous. While it is possible to identify a location on a digital map (e.g., dropping pin) and sharing that ‘pin’ with others, sharing pins doesn't typically work across disparate devices and systems, and the underlying reference for such pins is usually Lat/Lon coordinates that are long and cumbersome. Lat/Lon does not provide altitude or floor level information. Further, there is no effective system to identify, communicate, and differentiate one or more such locations verbally or in text with other humans, machines, messages, or with voice enabled devices and services.

Humans typically associate location referencing with names of known areas, streets, points of interest, etc., generic landmarks, and generally reference cardinal coordinate or directions (N, S, E, W, or NW, NE, SW, or SE) and distances in miles, feet, kilometers, or meters. Because there is no better alternative, humans are relegated to using long, subjective, non-standardized, fuzzy, colloquial, and incredibly variable Micro Location and device references. This is suboptimal and inadequate for humans and machines, and there is a significant need for a better system. For example, a person at an unknown location may use a traditional legacy street or postal addresses (e.g., 4590 MacArthur Blvd., Newport Beach, Calif.), but there are numerous inherent problems with street addresses, even at the whole-property level and certainly at the Micro Location level for locations in, around, or near known location or property. This is especially true for the growing needs for 3-dimensional Micro Location references to include height above ground (AGL), altitude, floor, and other 3D references. Further, does the address or reference of “4590 MacArthur Blvd. Newport Beach, Calif., 92660” reference the building at that location, the center of the building, the front or back door, the entrance from the streets to the public or private parking lots, the 7-acre parcel associated with it, or any of the offices or other locations on, near, or in the building? How do users and machines reference or communicate the Micro Locations on, in, or near that particular ‘street address’? Other examples include entry points from the street to the parking lot, various handicapped, vanpool, or other special parking areas, entrances to parking structures or buildings, trash storage areas, the exact parking space that a specific car is occupying, EV charging stations, specific offices, doors, and sub-components of the buildings, etc.).

The absence of any method for structured Micro Location references and the lack of normalization of traditional Legacy Street Addresses is another problem and the source of enormous efforts by geographers, mapping, and GIS software engineers. Legacy Street Addresses and related Micro Locations are by default typically often represented in numerous different ways by human referencing, voicing, and even inputting such addresses and locations everyday into numerous devices and software programs. There are significant industries, academic disciplines, and businesses devoted to disambiguating and curating traditional legacy street addresses throughout the world with varying degrees of success. However, these industries have not begun to address the growing 2D and 3D Micro Location needs and problems, and the current foundational infrastructure is inadequate to enable the next generation of RTML services, communications, and information needs. Thus, today there is an absence of a system to enable humans to address, reference, and communicate Micro Location such locations with the level of precision, brevity, and clarity desired or necessary for easy and quick human cognition and navigation. Finally, this is especially true in a growing multi-lingual voice environment with AI and voice enabled and other devices and systems.

While the development of GPS and related databases have altered the way humans and devices navigate at the RTML level outdoors, there are also numerous new micro-locating technologies and systems at the local level, which we refer to as local positioning systems (“LPS”). LPS focuses more on indoor and/or near-door locations in and around a campus, project, building, or other smaller feature or structure (generically Micro Locations) and can be extended to floor, elevation, device and infinitely precise locations. LPS can generate or use point clouds to create digital virtual twins with 1 centimeter precision. However, even without extremely precise LPS humans can view digital or other maps, images, video, and phone screens and visually or otherwise identify Micro Locations on that map with virtually infinite precision.

What is lacking currently is a method of identifying, verbalizing, voicing and otherwise communicating precise Micro Location referencing in a standardized way that is commensurate with the precision afforded by such technologies. For example, the common iPhone can only currently provide outdoor location information to within several meters without referencing other LPS systems, and those systems current don't provide much more precise or 3-dimensional references. Nevertheless, users have the ability to zoom in, view, and pinpoint one or more very precise Micro Locations or room and identify a Micro Location or device. However, there is no simple, brief, discrete and definitive way to write down, input, store, or communicate that precise Micro Location in any structured way that can be interpreted or used by virtually all other devices and services. Finally, many video, augmented reality (AR) and virtual reality (VR) systems are capturing RTML images, video, and information at scale of both real and virtual worlds (collectively, such technologies, devices and paradigms are collectively referred to herein as the “Metaverse”). However, the Metaverse is driven by imagery, digital virtual twins, radar, lidar, beacons, ultra-wideband LPS systems measurements, and other technologies to capture, curate, manage and distribute Micro Location information, but none of those technologies and systems currently provide any viable method for text and voice RTML communications.

What is needed are new systems and methods to 1) define smaller areas for Micro Location references, navigation, and services; 2) enable machines and humans to associate such areas with simple, short, and clear human-scale RTML references in three dimensions (x, y, and z); 3) enable such references to be shared in real-time between humans and machines; and/or 4) enable humans and machines to see, understand, and quickly and unambiguously communicate such Micro Locations. It would also be advantageous if the systems and methods enabled both abbreviated, structured pinpoint and area references of various sizes for simplified, human-friendly, standardized referencing as well as more efficient machine learning, geoanalytics, big data, and business intelligence through new data structures designed to enable linear v. non-linear geospatial search of RTML geospatial data.

### SUMMARY

The present application is directed to devices, systems and methods that create and enable very short, discrete numeric, alpha-numeric and/or alpha character Micro Location identifiers, names, numbers, name/number combinations, addresses, references, or shortcodes, which we refer to collectively as an MLIDs and RTML References and individually as an “MLID” or “RTML Reference”. MLIDs are also occasionally referred to herein as 1 M or 1-meter numbers. Importantly, MLIDs are created, structured, used and associated with discrete subject areas. Collectively, we refer to these well-defined or general areas as a “Subject Area”, or “SA.” By using AI and other methods to associate MLIDs to relevant Subject Areas, humans and machines can more quickly, accurately, yet succinctly, identify, reference, and communicate precise Micro Locations and access Micro Location information, services, and communications. MLIDs and RTML References provide a radically new system for Micro Location references that are easier for humans to use across virtually all devices, systems, languages, software, and platforms. The primary objectives of the system are simplicity, brevity, precision, interoperability, and flexibility for humans. However, the system also has significant advantages for machines and computer programming, AI, AR, ML, and VR, and ADs, both internal and dependent of human interfaces as well as human interfaces and AI because of the added benefit of facilitating more efficient and effective human interfaces and communications.

In accordance with one example, a system is provided for identifying and referencing micro-locations with one of one or more alphanumeric shortcode micro-location identifiers used for human to human, human to device, and device to device communications, input, output and displays including an electronic device comprising a user interface and a display; and one or more processors configured to enable a user to enter, input, speak, see, select, or communicate, using the user interface of the electronic device, one or more micro-location identifiers with reference to a subject area; determine the subject area and assigned reference subject area; and resolve and use the micro-location identifier with reference to a subject area.

In accordance with another example, a method is provided for identifying and referencing micro-locations with one of one or more alphanumeric shortcode micro-location identifiers used for human to human, human to device, and device to device communications, input, output and displays, the method comprising enabling a user to enter, input, speak, see, select, or communicate using an interface of an electronic device, one or more micro-location identifiers with reference to a subject area; determining the subject area and assigned reference subject area; and whereupon one or more processors resolve and use the micro-location identifier with reference to a subject area.

In accordance with still another example, a system is provided for identifying and referencing one or more micro-locations with reference to a first location with two or more alphanumeric shortcode micro-location identifiers for human-to-human, human-to-device, and device-to-device identification, designation, communications, input, output and displays such that the number of digits displayed in the micro-location identifier are the minimum number of digits necessary to discretely identify the one or more micro-locations relative to the first location, the system including an electronic device comprising a user interface and a display; and one or more processors configured to display, on the display of the electronic device, a number of least significant digits of a two-dimensional xy coordinate system based on the distance from a known location such that the minimum number of digits displayed are the minimum number of digits necessary based on the coordinate system and the distance from a third location; enable a user to enter, input, speak, see, or select, using the interface of the electronic device, one or more micro-location identifiers with reference to a subject area; and resolve and use the micro-location identifier with reference to a subject area.

In accordance with yet another example, a method is provided for identifying and referencing one or more micro-locations with reference to a first location with two or more alphanumeric shortcode micro-location identifiers for human-to-human, human-to-device, and device-to-device identification, designation, communications, input, output and displays such that the number of digits displayed in the micro-location identifier are the minimum number of digits necessary to discretely identify the one or more micro-locations relative to the first location, the method including displaying, on a display of an electronic device, a number of least significant digits of a two-dimensional xy coordinate system based on the distance from a known location such that the minimum number of digits displayed are the minimum number of digits necessary based on the coordinate system and the distance from a third location; enabling a user to enter, input, speak, see, or select, using an interface of the electronic device, one or more micro-location identifiers with reference to a subject area; and whereupon one or more processors resolve and use the micro-location identifier with reference to a subject area.

Other aspects and features of the present invention will become apparent from consideration of the following description taken in conjunction with the accompanying drawings.

### BRIEF DESCRIPTION OF THE DRAWINGS

The invention is best understood from the following detailed description when read in conjunction with the accompanying drawings. It is emphasized that, according to common practice, the various features and design elements of the drawings are not to-scale. On the contrary, the dimensions of the various features and design elements are arbitrarily expanded or reduced for clarity. Included in the drawings are the following figures.

FIG. 1 is a diagram showing exemplary component systems and relevant parties and key components of an overall RTML System, including the operators of the RTML System, Owners of properties and SAs, RSAs, and MLIDs, and the various components of information clearinghouse, data and information flows to various third-party developers, systems, and services.

FIG. 2 is a diagram showing exemplary component systems and relevant parties features of the RTML Systems, including the flow of RTML data and information through the clearinghouse to map providers, developers, services, and end users as well as the use, adjustment and other data and payments flow from such parties to owners and operators of properties and SAs.

FIG. 3 is a diagram, showing exemplary component systems and relevant participants and relationships related to the creation, storage, management, distribution, tracking and use of SAs, RSAs, and MLIDs and RTML Registry System as access systems and methods that may be included in an example of an RTML Registry System.

FIG. 4 is a diagram, showing alternative categories and examples of alternative methods for defining and implementing RSAs, including Global Systems, local portions of Global Systems, specifically defined SAs with egocentric anchors and variable, and custom designed RSAs.

FIG. 5 is a diagram, showing exemplary structural components of the Features and Modules of the RTML System, including registry and verification, access and control tools, accounting and micropayment engine, and data exhaust, reporting, iterative improvements and analytics.

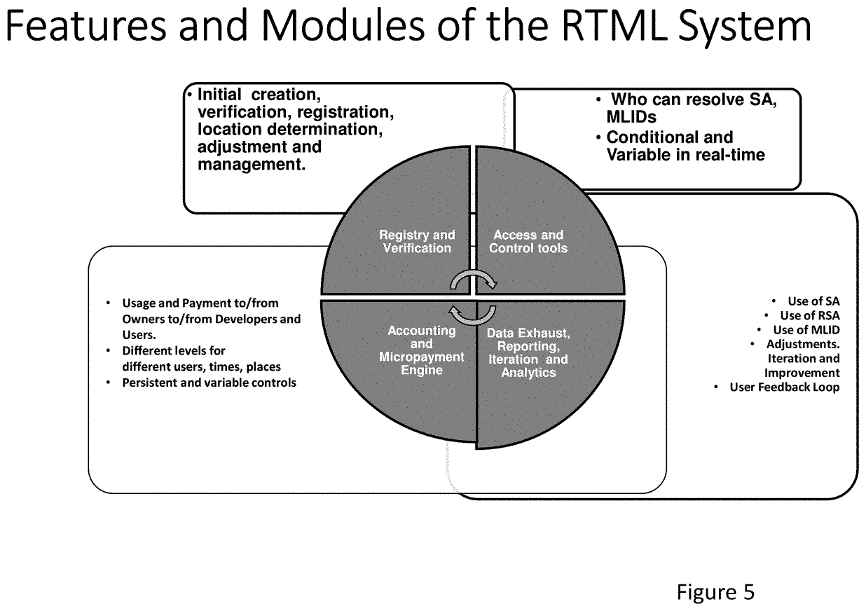

FIG. 6 is schematic drawing showing exemplary MLID access and processing steps, which may include the use or selection of the SA or RSA, the encoding and decoding of the MLID, optionally accessing information and services related to the MLID, usage logging, and optional iteration and improvement of underling SA or MLID information or RSA implementation.

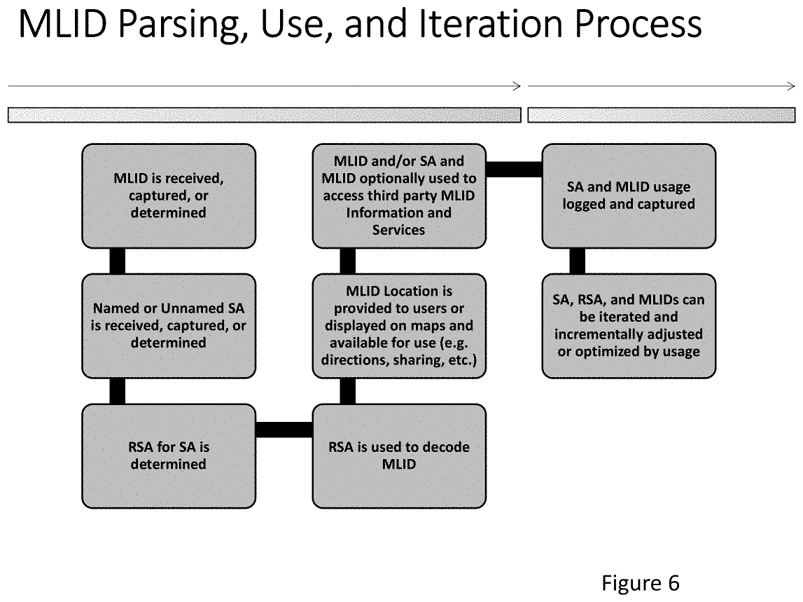

FIG. 7 is a schematic showing an exemplary MLID resolution logic and flow base on the identifiability and availability of a SA or optional SA or the creation of an appropriate SA for the MLID and/or future MLIDs.

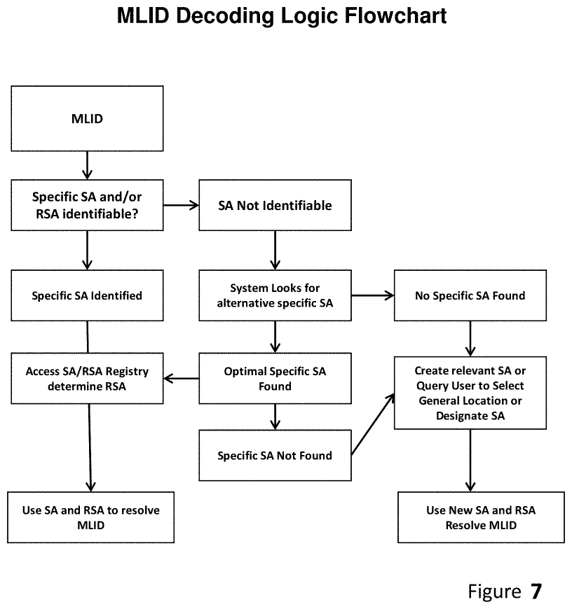

FIG. 8 is a schematic showing an exemplary network architecture of a system for registering and/or using MLIDs according to the systems and methods herein.

FIG. 9 is a diagram showing the alternative SAs and RSAs with reference to a portion of a Global System (UTM) where the SAs are not wholly contained within a UTM cell.

FIG. 10 illustrates an exemplary logic sequence and flow for automatically determining the appropriate RSA for any given SA and a schedule of options for likely number of digits based on the expected precision and options for ensuring Geospatial Logic (as defined below).

FIG. 11 illustrates two exemplary processes (100 Meter and 1 kilometer) for automatically determining the number of digits depending on the relationship between an SA and RSA based on the size and coverage of the SA relative to the underlying RSA and the desired level of precision.

FIG. 12 contains a diagram of an exemplary sequence and flow for selecting or determining the format of the underlying RSA based on the desired operational Geospatial Logic and precision as well as the sequence and flow for owners selecting RSAs with encryption, encryption keys or randomized without Geospatial Logic.

FIG. 13 illustrates an exemplary logic sequence and flow for processing defined SA names and references with existing named places, identities, as well as iterating associated names and references to SAs in real-time, including use AI to monitor user usage and associated area references to improve future SA names and references.

FIG. 14 contains a sequence of Map Images illustrating an example of an exemplary 100×100-kilometer SA and RSA for coverage the area around a major city, with alternative MLID area references structured to provide standardized 10 kilometer, 1 kilometer, 100 meter, 10 meter, and 1 meter precise references with 2, 4, 6, 8, and 10 digit MLIDs, respectively.

FIG. 15 contains an exemplary map and satellite image showing MLID references for specific locations on or around a lake.

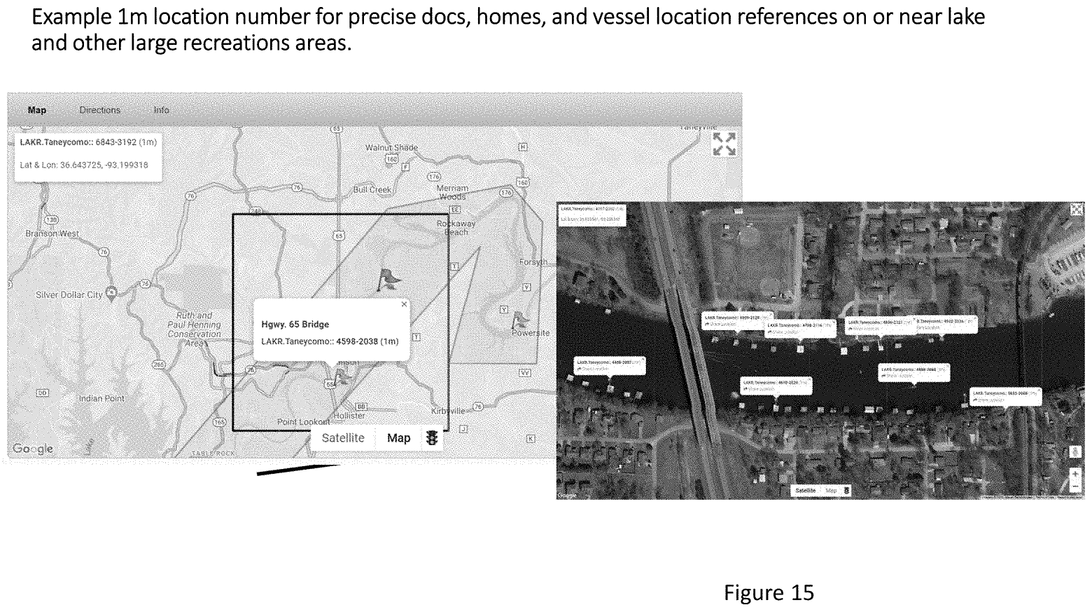

FIG. 16 contains a diagram of an example of a variable RSA enabling variable length MLIDs dependent upon the relative distance from the anchor for the SA and RSA in order to minimize the required number of digits in the MLID for any given Micro Location.

FIG. 17 contains a sequence of Map Images illustrating an example of an automated variable RSA with MLIDs of 2, 4, 6, and 8 digits based on the location of the referenced Micro Location relative to the anchor of the SA.

FIG. 18 contains an exemplary map image showing variable RSA LIDs of 4, 6, and 8 digits for multiple locations based on the distance from the anchor of the SA.

FIG. 19 contains an exemplary satellite image showing variable RSA LIDs of 4, 6, and 8 digits for multiple locations based on the distance from the anchor of the SA.

FIG. 20 contains an illustration of defining three dimensional SAs and RSA around buildings as well as Micro Locations for rideshare, interiors of buildings, and drone landing zones in addition to an example of defined drone landing and approach paths based on the SA and RSA.

FIG. 21 contains an example of defining a three-dimensional SA and RSA for a building together with using MLIDs to organize, capture and display information related to the underlying property and building as a digital clone or twin of the as built building.

FIG. 22 contains exemplary methods for sharing MLIDs for Micro Locations related to specific properties, SAs, and RSAs displayed and shared over text messages and emails.

FIG. 23 shows an example of sharing multiple MLIDs assigned to various locations within a specific SA and RSA together with RTML information accessed with reference to the SA and MLIDs.

FIG. 24 shows an example of a mobile application displaying MLIDs to reference and share Micro Locations relative to a specific SA and RSA and various related functions for text, chat, mapping and sharing.

FIG. 25 shows an example displaying MLIDs on wearable devices to reference Micro Locations in an SA or RSA for a room.

FIG. 26 shows an example of a sequence of screenshots from a mobile web application enabling users to quickly launch alternative rideshare services for trips to and from a specific MLID to compare prices, times, and services.

FIG. 27 shows an example of an SA, RSA, and MLID for a large stadium with MLIDs for specific Micro Locations including seats with alternative RSA structures for the MLIDs.

FIG. 28 shows various exemplary components of an AI and ML engine to capture and analyze usage of SA, RSAs, and MLIDs to improve and enhance the references and use of SA, RSAs, and MLIDs as well as key components of the AI systems.

FIG. 29 shows examples of a spreadsheet database using MLIDs associated with records and fields to designate and identify Micro Locations relative to such SA.

FIG. 30 shows an example of utilizing MLIDs as geospatial locators and identifiers in an exemplary spreadsheet database to enable the use of existing tools for geospatial and RTML searching, sorting, manipulating, and other functions.

FIG. 31 shows an example of using MLIDs as geospatial locators with variable sized areas and levels of precision in an exemplary spreadsheet database to enable using existing spreadsheet tools for advanced geospatial and RTML searching, sorting, manipulating, and other functions.

FIG. 32 shows an example of using MLIDs as hierarchical geospatial locators representing variable sized areas and levels of precision in an exemplary spreadsheet database to enable using existing spreadsheet tools for advanced geospatial and RTML searching, sorting, manipulating, and other functions.

FIG. 33 shows a diagram of an example of determining and using Functional Proximity with MLIDs to determine optimal rideshare drop-off and pickup locations relative to intended destinations.

FIG. 34 shows a diagram of an example of determining and using Functional Proximity with MLIDs for locations inside building structures to determine optimal rideshare drop off and pickup locations.

FIG. 35 shows a diagram of an example of determining and using Functional Proximity with MLIDs for locations inside buildings and other structures to determine optimal rideshare drop off and pickup locations from entrances to such structures.

FIG. 36 shows an example of determining and using variable sized SAs, RSAs, and MLIDs for elongated areas such as rivers, roads, highway, etc.

FIG. 37 shows an example of naming and associating SAs and MLIDs for RSAs based on components of Global Systems for areas of various sizes.

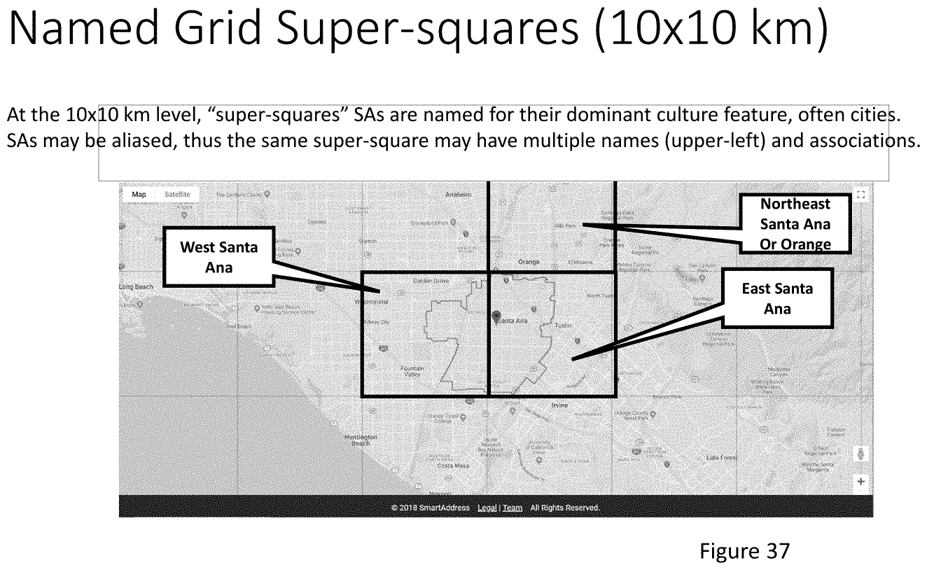

### DETAILED DESCRIPTION

Before the examples are described, it is to be understood that the invention is not limited to particular embodiments described, as such may, of course, vary. It is also to be understood that the terminology used herein is for the purpose of describing particular examples only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and exemplary methods and materials are now described.

It must be noted that as used herein and in the appended claims, the singular forms “a,” “an,” and “the” include plural referents unless the context clearly dictates otherwise. Thus, for example, reference to “a compound” includes a plurality of such compounds and reference to “the polymer” includes reference to one or more polymers and equivalents thereof known to those skilled in the art, and so forth.

The systems and methods described herein may provide a radically new approach, starting with a small, nuclear element of location at the Micro Location level. While all existing Global System start with a global system and essentially use a top-down approach to add more digits to achieve more granularity and precision, the systems and methods herein reverse that approach with a bottom-up approach, whereby Micro Locations are provided as a very short, unique MLID reference that is unique within a certain, generally very small area that can vary depending on the use, context, or need. This short MLID reference can then be increased as necessary to maintain uniqueness as the Subject Areas become larger, but typically only to the extent necessary for any given or relevant Subject Area or use. To illustrate, a 2D Micro Location reference for a 1×1-yard area, (e.g. 12.83) that is only unique within a small area of, for example a 100×100-yard area around a given house, apartment, or other building, is nevertheless adequate for the vast majority of needs and uses in and around any such apartment, residence, or building. It is unlikely that the reference to the 12.83 MLID near a house in Phoenix, Ariz. is also relevant to referencing a Micro Location near a house in Paris, France. This new bottom-up approach enables extremely short yet unique and discrete MLIDs for the vast majority of Micro Locations uses and systems vis a vis known or determinable Subject Areas.

The system enables Micro Location references of varying precisions and scopes to be referenced or denoted by a very short unique MLID (usually from 2 to 8 characters/digits relevant to areas of varying sizes and scope). These areas include but are not limited to: a) a specifically named or associated relevant area, or b) an area derived, organized, and curated in such a manner that the MLID is nevertheless discrete with a relevant area, distance, or use case. While the SA can be named and combined with the MLID in a “Name-plus-Number” (“Nallo”) MLID reference for specific names or identified localized or existing named geographic area, the system also enables use without the Nallo combination by using AI and other methods to combine MLID references with other information known or ascertainable to ensure that the MLID can effectively communicate the exact RTML location, device, etc. Further, formally named SAs are not required to disambiguate MLIDs although they are often helpful and likely to become a dominate component of many MLID references. Further, the system enables the owner/creator of certain SAs and MLIDs to define one or more related RTML reference systems for the SA (each a “Reference to Subject Area”, or “RSA”) based on other methods or arrangements of letters and/or digits. There may be numerous owners of identically named SAs (requiring contextual disambiguation), and a single SA can also be jointly owned by numerous owners in a manner that requires the approval of the multiple owners (in such manner as they agree) to modify or share use of the SA, including any derivative RSAs.

The systems and methods herein may enable users and machines to definitively reference MLIDs for RTML references for Micro Locations associated with an SA, and all Micro Locations can be associated with one or more SAs in various ways. An RSA for an SA will typically, but not necessarily cover the entire extent of an SA to enable MLID to be effective within the SA.

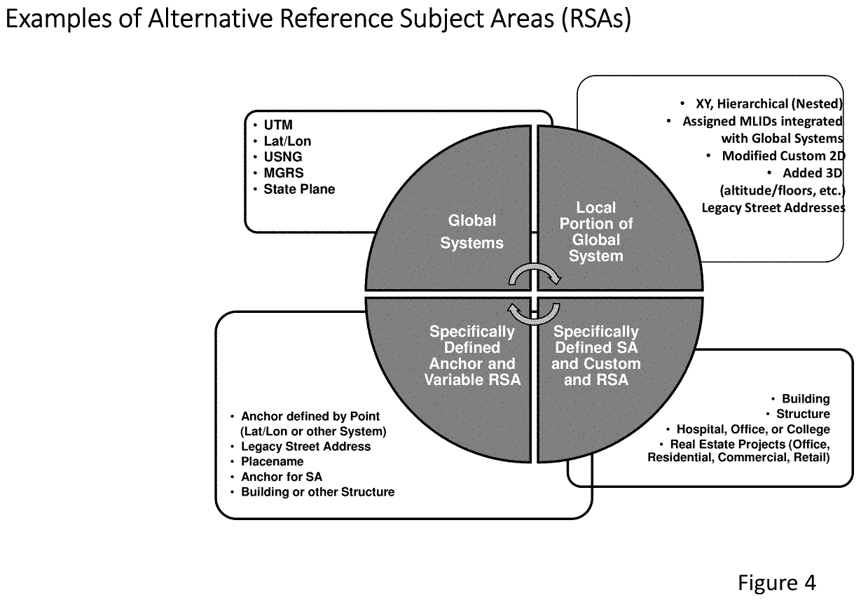

The RTML Reference system for any given RSA can be determined in a number of different ways, e.g., as referenced in FIG. 4, including, but not limited to: 1) unique, SA and location specific egocentric, i.e. user-or location centered, coordinate, location references systems anchored as selected by the owner/creator or by the system, 2) systems that coordinate and/or are based on and congruent with allocentric Global Systems, 3) hierarchical, sequential, hybrid, segmented, or otherwise structured naming, numbering and referencing systems, 4) assigned MLIDs for specific Micro Locations, and/or 5) hybrid combinations of the foregoing methods for one or more Subject Areas or subject areas.

While MLIDs based on coordinate systems will typically be a series of xy or hierarchical pairs of numbers that are based on or consistent with various interval measurements, RSAs may also contain a combination of both coordinate references (e.g. xy, or hierarchical) and specifically designated or assigned identifiers. In such instances, the RSA may be defined to use MLIDs with an odd number of digits to signify assigned Micro Locations where MLIDs with an even number of digits are used pursuant to the RSA algorithms. Further, because in many examples, MLIDs will have 1 meter or great precision, it is possible that RSAs can be designed to use both odd and even number assigned MLIDs notwithstanding that the assigned MLIDs contain an even number of digits, and coordinate MLID references that would otherwise be assigned to a coordinate can merely automatically reference an adjacent coordinate. For example, if the owner of a building defines an RSA for a building as a 4-digit xy coordinate yet wants to assign specific rooms a 4 digit numeric MLID to coincide with the floor and room number (e.g., 3412 for room 412 on the third floor), the RTML system can nevertheless assign a coordinate for 3412 to 3413 or some other contiguous Micro Location.

The owner of the RSA has flexibility to define the basis of the RSA for any particular SA with flexibility to use any combination of methods to assign or determine MLIDs. It is important to point out that RSAs and MLIDs for any given SA can include 3-dimensional references including altitude above sea level ground level, etc. Importantly, for buildings and other structures, the SA, RSA, and MLIDs often need further structural definition based on floors or other levels in a building. Knowing that the Micro Location is 48 feet above ground level does not provide adequate information on which floor of the building the subject Micro Location is located, or how to navigate and wayfind to that specific Micro Location represented by the MLID. MLIDs can also provide access to such RTML information in order to expedite emergency, delivery, or other services to or near that Micro Locations.

Notwithstanding such flexibility, the data structures, user interfaces, user experience, visual presentation and communications, access APIs and other algorithms and methodologies are designed to be standardized and simplified for both humans and machines as well as for various computational (e.g., distance and bearings, proximity, interval measurement, etc.), search, structure data, and other capabilities for computers, database, data analytics and machines.

Optional names for a specific SA may be a discrete human friendly identifier (e.g., NBCA for Newport Beach, Calif.), or NBCA.4590MacB for the x acre parcel commonly referred or associated with a Legacy Street Address like 4590 MacArthur Blvd, Newport Beach, Calif., 92660, or NBCA.4590MacB.ConfRm5 for a specific conference room inside a building at that address. However, it is not necessary to use such optional identifiers as the RTML system will be capable of associating various SAs for given areas and MLID Micro Locations using a variety of methodologies, including AI, which in many cases can eliminate the need for specific SAs.

For example, the MLID “734.123” associated with “NBCA.4590MacB” can identify a precise Micro Location within the environ of NBCA.4590MacB, which may or may not be an associated and assigned SA. Further, as discussed elsewhere, the MLID 734.123 can be derived by a Global System, a localized or 2D, 3D, or other custom coordinate system, or can be assigned or specified with respect to an SA to a specific designated Micro Location or device.

Importantly, predetermined SAs and RSAs are optional and can be defined and optimized for human and/or machine use. Through AI and ML, SAs, RSAs can analyzed, inter-related, and larger patterns of spatial area structure understood, adjusted, and improved with usage. SAs and RSAs definitions and environs thus facilitate ‘fuzzy’ or ‘elastic’ search, Natural Language Processing (“NLP”) and AI, while still providing definitive and precise RTML MLID Micro Location references.

The overall RTML system includes a registry and clearinghouse for all specifically named or otherwise designated SAs and RSAs and the related metadata, including their selective visibility and associated spatial referencing systems to all or specific users. Notwithstanding the fact that there will be numerous geospatial MLID and MLID referencing systems, MLIDs will all generally use similar and familiar, standardized human machine interfaces (HMIs) and visual displays to facilitate interoperability across devices, typically a few numeric or alpha-numeric digits depending on the size of the SA and RSA or other relevant area and context of the MLID usage. Thus, from a human interface, cognition, awareness, and simplicity points of view, the consistently of MLIDs avoid the necessity of human understanding or learning disparate systems. Much like phone numbers for telecom and domain names for the internet, MLIDs will just work and enable humans for the first time ever to reference Micro Location with brevity, precision, and clarity with each other and with machines.

SAs, names and MLIDs inherently cater to the human notions of location, georeferencing, and wayfinding based on landmarks, i.e., named places, typically using the local language ( [symbol] vs. Shanghai) or human scale proximity. Further, the RTML system facilitates multi-lingual communications and usage because of the emphasis on brevity, compactness, and limited words and alpha numeric character needed to reference a Micro Location. For example, Shanghai 4762.8812 and [symbol] 4762.8812 (its Chinese denotation) present identical MLIDs for the same Micro Location near Shanghai with the common name for the SA being combined with only a few numeric characters that are more easily used across various languages than long and cumbersome Legacy Street Addresses and other colloquial description across multiple languages. Thus, MLIDs greatly enhance RTML Micro Location references across different devices, services, languages, and dialects.

However, by design MLIDs are inherently multi-lingual and can be used with various languages and references as well. In a world where foreign travel is common, language limitations often inhibit location referencing and communications. Alias SAs and even MLIDs can be defined and/or used in multiple languages, facilitating a multi-lingual, precise RTML location referencing solution that works globally with limited characters and digits, and MLIDs which are extremely short and typically exclusively or primarily numeric, further allowing MLIDs for subsidiary areas and points to be easily identified globally across multiple languages, with both precision, brevity, and security—impossible today.

There is also a need for LPS systems and methods to capture, access, and use more granular RTML information. Current video and point-cloud systems may know or capture that there are 7 doors on the 5^{th} floor in Suite 542 of Building X, and perhaps identify the exact location of every door with centimeter precision in images, point clouds or other similar machine data structure. However, point clouds and video do not currently capture and provide abbreviated, simple human readable interfaces or RTML MLIDs for such doors, nor access to RTML information about what is behind every such door. MLIDs enable users to identify and reference Micro Locations for voice interfaces and create an establish names, keywords, and other references via MLIDs. This RTML information is both structured and unstructured, and usually dynamic. MLIDs can then be used to not only reference, but to access information about, and interact with Micro Locations and devices. Further, LPS images, lidar or other devices MAY be able to capture a light or other switch on the wall, but they do not capture and provide universal access to information about what the switch controls. The RTML system and MLIDs facilitates identification, referencing, and accessing RTML information about any such Micro Location, in this case a switch device, relative to relevant SAs without the necessity of utilizing a Global System, most of which is irrelevant to the SA. Thus, the SAs, RSAs, and MLIDs can be optimized for use at the Micro Location level. Finally, in the absence of VR or AR interfaces, and even with such devices and interfaces, current georeferencing systems are not human friendly, and the systems and methods herein may enable and substantially improve and help and assist in HMI, human and AI cognition, interactions, and communications and usage of this RTML information for AR, VR, and the new Metaverse of digital content.

One aspect of the systems and method enabling MLIDs for given SAs is the ability to utilize the least significant digits (“LSDs”) necessary to provide the desired level of 2D, 3D or other coordinate precision for the size any given SA. For example, if the RSA is global UTM, and the SA is 25 meters in maximum extent and the desired precision is 1 meter, 2D MLIDs need only be 4 digits to ensure that all known and possible MLIDs within the SA are unique and provide a discrete reference. If the RSA is Lat/Lon and the desired precision is approximately 1 yard and the SA is approximately 50 yards in extent at the equator, then 2D MLIDs only need 4 digits to ensure that all MLIDs in the given SA are unique. For example, assume a Micro Location with a latitude of −117.859254 and a longitude of 33.665333 and a Subject area of less than 50 yards in extent. In one example of the RSA based on Lat/Lon, the MLID can be derived from the last three least significant digits of the foregoing, or 254.333. And a nearby Micro Location in the same SA can be referenced as 243.340. Because the RTML system is associating the MLID with a known or otherwise determinable SA near −117.859 longitude and 33.665 latitude, it is not necessary for the user to use the full and cumbersome latitude longitude and can use the MLID 254.333 or 243.340 to reference two proximate locations. Similarly, all users of the RTML system can obtain information about the locations, record them, store them in a database or spreadsheet, text, email or otherwise communicate them.

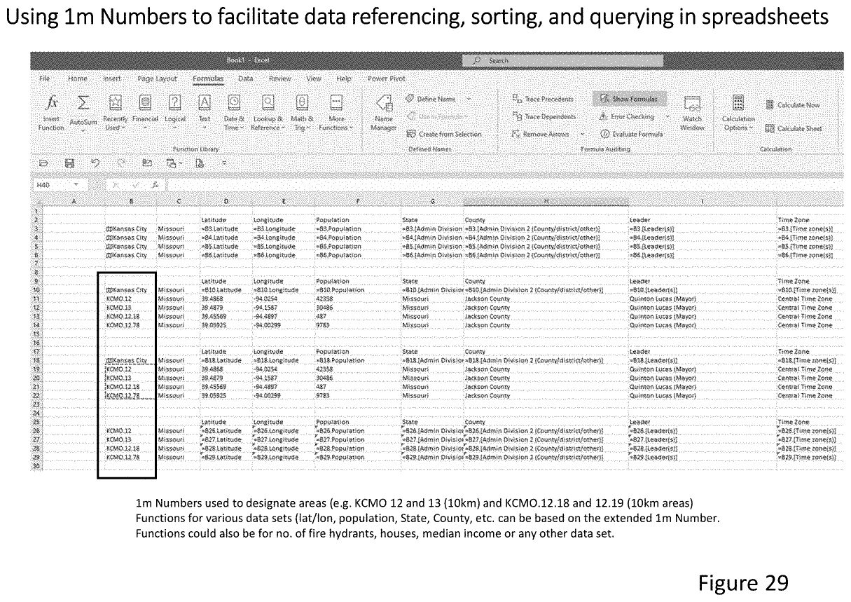

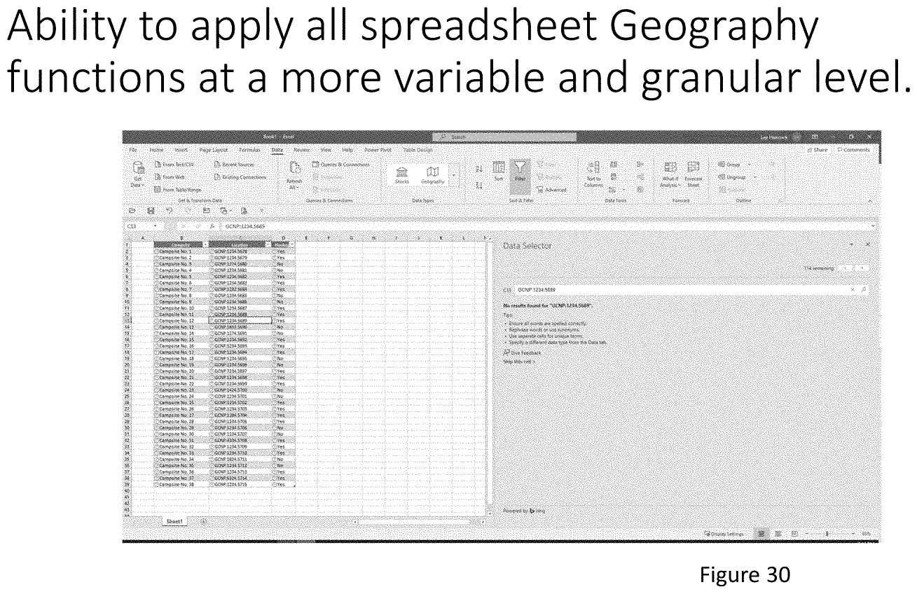

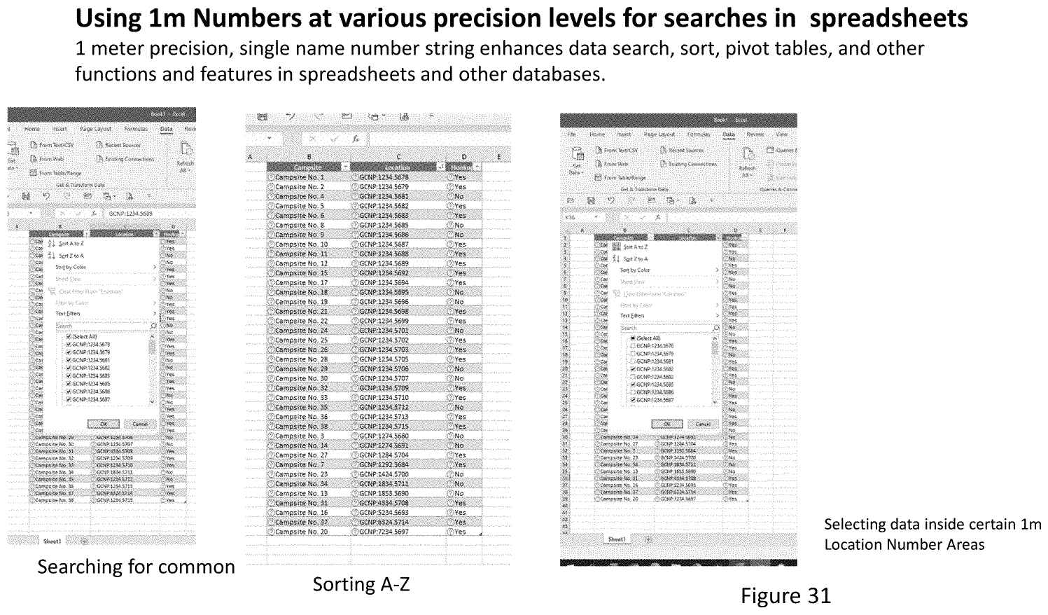

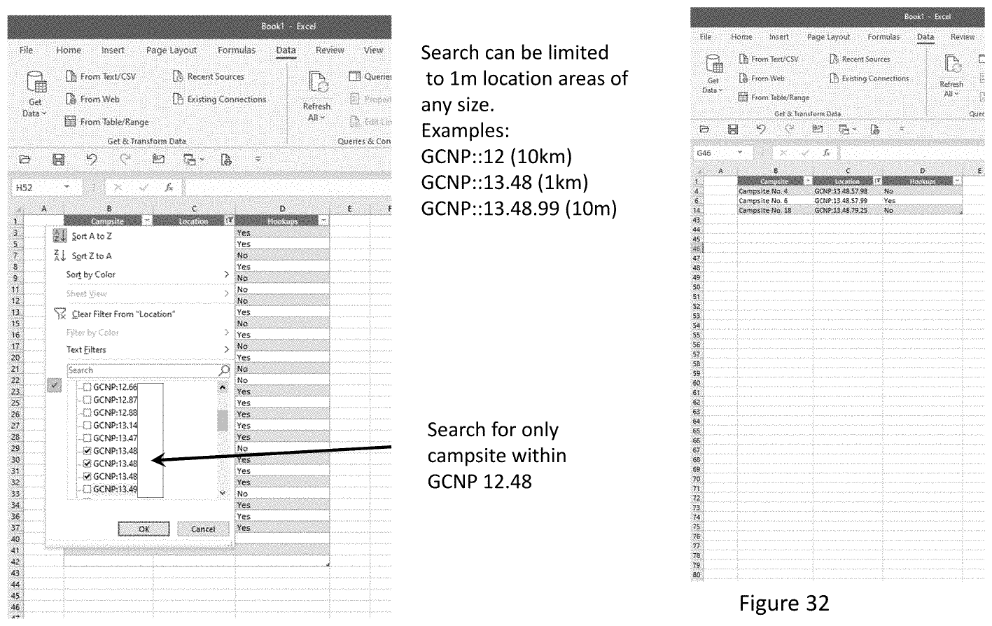

One of the variable options for SA, RSAs, and MLIDs is Geospatial Logic. While in many cases the characters of the MLID are irrelevant as long as they work (similar to the phone number system), there will be cases where humans and machines are interpreting the MLID characters (often numeric) and mentally creating geospatial relationships. We define “Geospatial Logic” to include spatial, relational, and other characteristics in the MLID that enable: 1) the ability of humans (and AI and other machines perhaps processing in ways similar to how humans think) to associate a given 2D or 3D MLID with xy or xyz coordinates with a location relative to a known area, place, thing, in particular relative to global cardinal directions (north, south, east, and west) and orientations and 2) various calculations, algorithms, and relationships underlying the MLID characters/digits such that machines (and occasionally humans in some circumstances) can perform calculations, searches, organized data storage and analytics, structures, area and linear interval measurement, size, range, bearings, etc., examples of some of which are included in FIGS. 29 through 32. In many cases RSAs will be structured or used to enable Geospatial Logic such that larger numbers in, for example, a 2D xy coordinate system will be larger for points further north and east. Thus, Geospatial Logic would ensure that an MLID 734.815 is north and east of 123.238. Special systems and processes are required in order to achieve Geospatial Logic for certain SAs, RSAs, and MLIDs.

Also note that for the MLID based on Lat/Lon to maintain Geospatial Logic it is necessary to either add more least significant digits (in this case a 9 and 5 to create a slightly larger MLID of 9254.5333 (in this case the geospatial logic is reversed because this location is in the western hemisphere and locations further east have smaller longitudes).

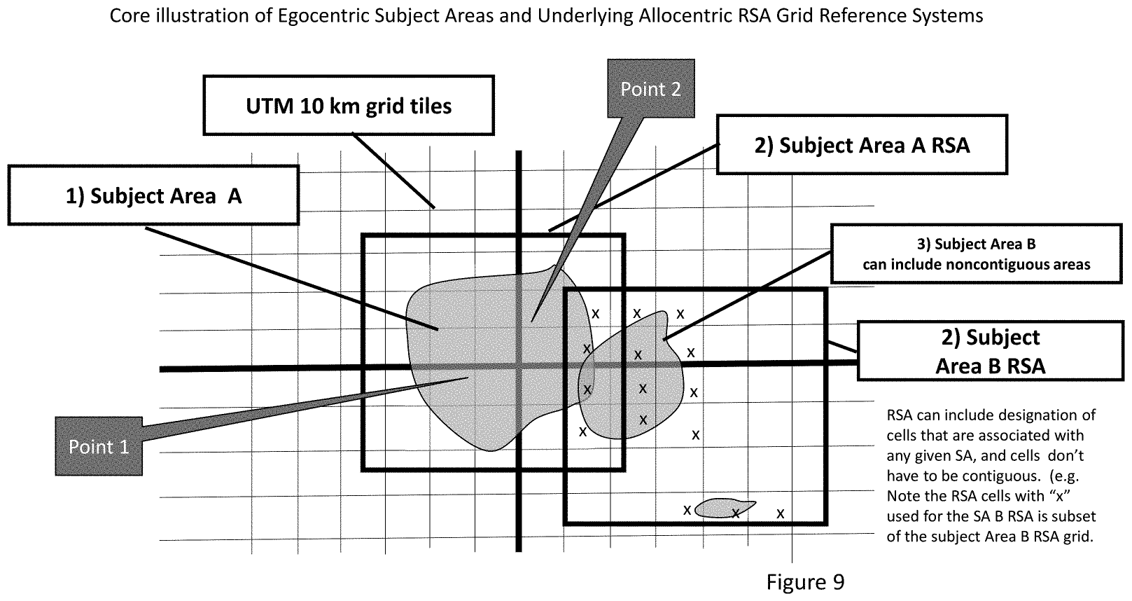

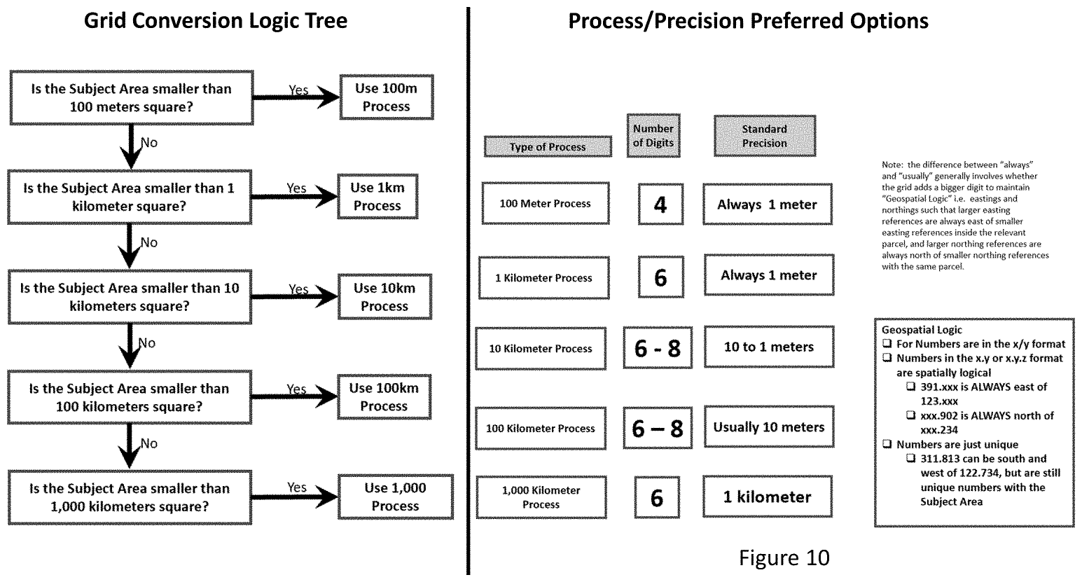

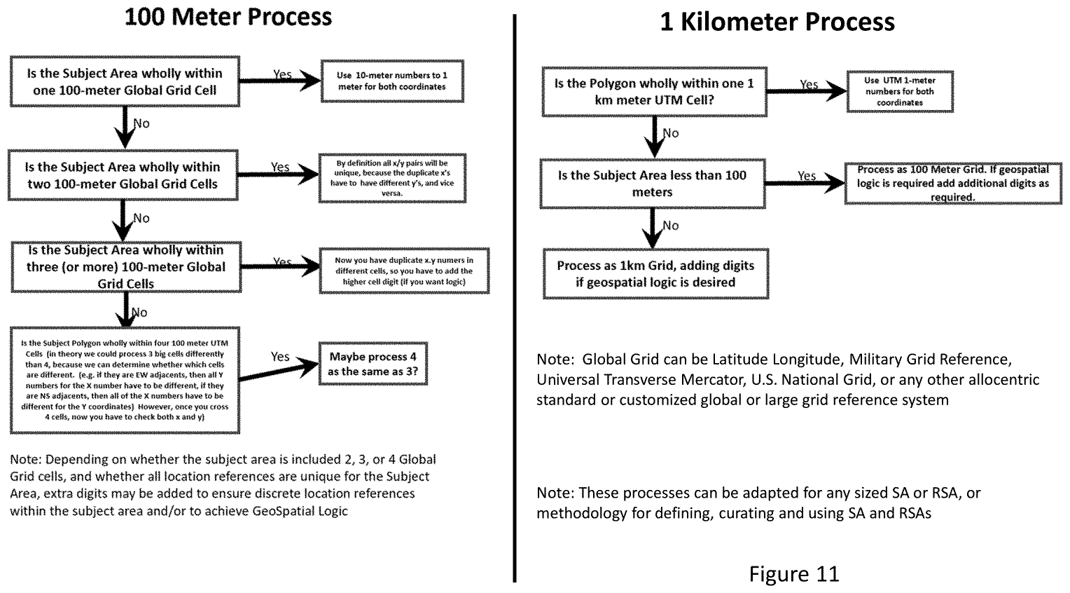

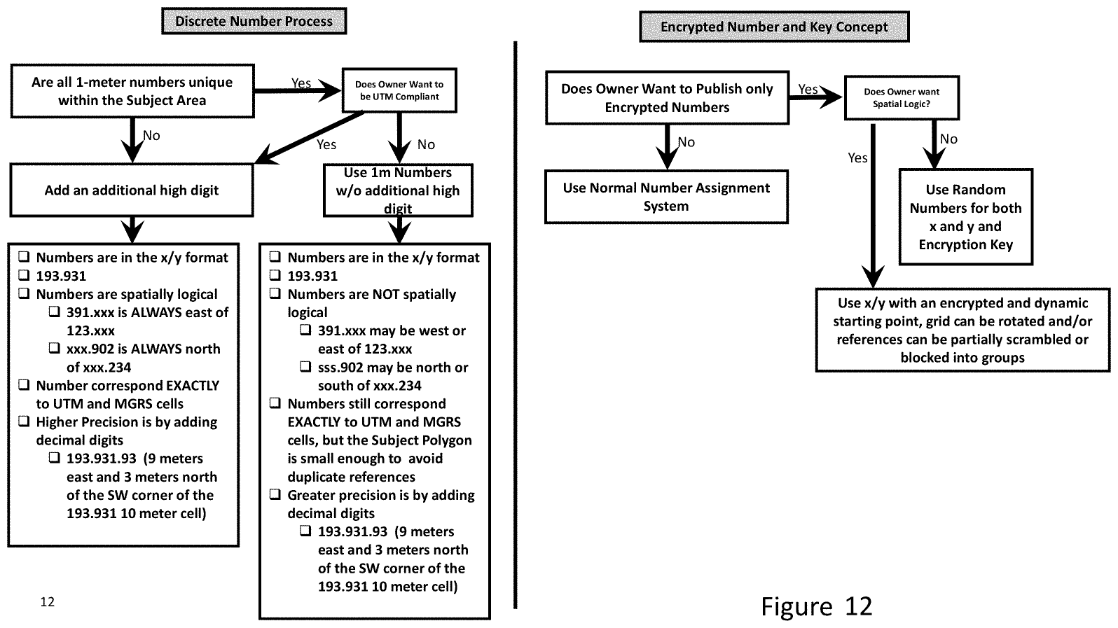

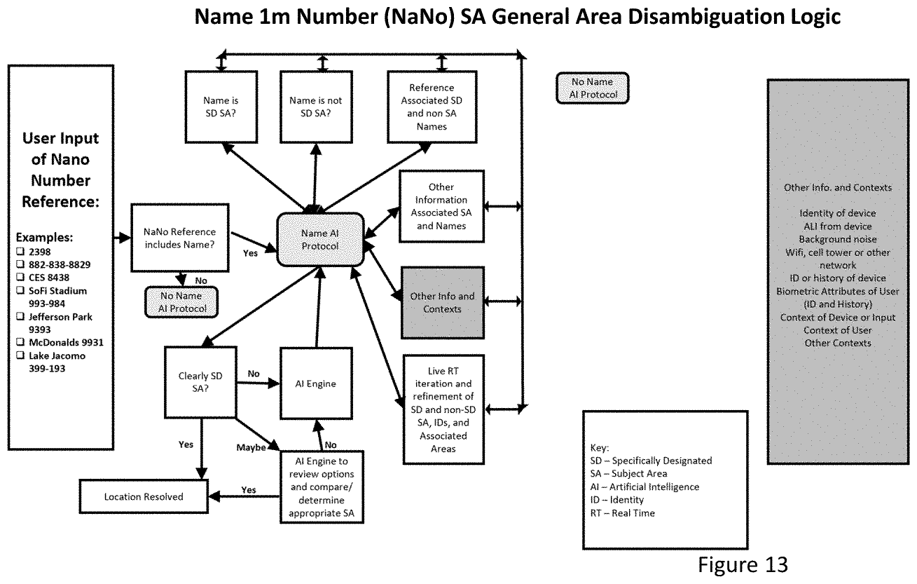

A simpler example can be illustrated with an egocentric, customer SA and RSA based on a metric system used by a different RSA based on a desired 2D precision of 1 meter and a metric based coordinated system within a 100×100-meter cell for an SA of less than 100 meters that is more or less congruent with magnetic (as opposed to true) north. In this example, a 4 digit MLID provides 1-meter precision for any of the 10,000 1-meter cells within the 100×100-meter coordinate system, and such MLIDs will maintain Geospatial Logic. That is MLIDs with greater numbers associated with the x and y in the xy format will be north and east of MLIDs with smaller such numbers. To further illustrate the necessity of more detailed processes as illustrated in FIGS. 9-13, if the RSA for the same SA is based on a Global System such as USNG, it is necessary to determine whether the SA is wholly within a 100×100-meter USNG cell. If it is, then the RSA will maintain Geospatial Logic with a 4-digit MLID. If it isn't, then it is necessary to adjust the RSA by adding digits to ensure Geospatial Logic. Without describing every detail, for this desired precision and size SA, assuming the SA is not wholly within the 100×100-meter USNG cell, it is possible that the Micro Location with an MLID 43.21 is actually north and east of the Micro Location with an MLID of 74.62, which does not provide Geo spatial Logic. To achieve Geospatial Logic in this example, the RSA must be defined to include 6 digits notwithstanding the extent of less than 100-meters, such that the MLIDs of 843.721 for the Micro Location that is northeast of the Micro Location with the MLID of 774.662, achieving Geospatial Logic if such is desired.

SAs, RSAs, and MLIDs may be structured and assigned in with or without Geospatial Logic in a manner such that the distance, bearing, area, etc. between or relative to any two or more Micro Locations can be quickly determined with computational functions because of the distance bearing relationship between any location numbers if the numbers are based on a standardized references system, e.g., USNG. For example, if the 6-digit MLID for a given RSA has 1-meter precision, then 345.176 is 112 meters east and 52 meters north of 233.124, and that can easily be computed to determine the distance and direction between the two locations. Further, the standard distance and bearings can be either stored in tables or computed algorithmically and accessed via various functions to eliminate the need for more CPU heavy Lat/Lon computations to determine the distance and direction between any two points within various standardized grids covers various Subject Areas. The system further facilitates the creation of tables and various optimal lookups for doing proximity searches, distance and direction determinations (calculations or database lookups), or organizing and querying large quantities of geospatial data for storage, search, and analytics.

Finally, while achieving Geospatial logic requires significant new steps and processes, it is possible that Geospatial Logic will become irrelevant as more and more geospatial processing and visualizations are assisted or exclusive used over devices and displays such that the primary factor in defining SAs and RSAs will be brevity and utilizing the fewest digits necessary to ensure that MLIDs are unique and functional for any given SA. Similarly, as taught elsewhere herein, RSA may utilize encrypted, assigned, and/or random numbers for any given SA, which in many cases are inconsistent with Geospatial Logic, making it irrelevant.

To illustrate, in FIG. 9, Point 2 is northeast of Point 1. Geospatial Logic would necessitate that the MLID (with an RSA in the xy coordinate alternative) for Point 2 would consist of an x number and a y number that are both larger than the respective x number and the y number of Point 1. However, in this example because the extent of the SA covers multiple 100×100-meter cells in the given RSA (UTM), the 4 digit MLID for Point 2 (MLID=12.21) is not greater than the 4 digit MLID for Point 1 (MLID=89.98). Therefore, there is no Geospatial Logic because the MLID for Point 2, which is north and east of Point 1, has a smaller x and y component than the x and y component for Point 1. Thus, the 4-digit MLIDs for this SA and RSA do not have the advantage of Geospatial Logic for humans and machines. If Geospatial Logic is desired, to achieve Geospatial Logic the RTML system, or the RSA for the given SA, can be predetermined or automatically or manually adjusted to increase the length of the MLID to 6 digits, such that the 6 digit MLID for Point 2 is now 312.421 and the six digit MLID for Point 1 is 289.398, thereby achieving Geospatial Logic because in both cases the x and the y value for Point 2 are greater than Point 1, which is consistent with Geospatial Logic.

While the systems and methods herein can be adapted to use MLIDs using LSDs derived from latitude and longitude, Lat/Lon is sub-optimal for various reasons, including that in the Southern and Western hemispheres Latitude and Longitude coordinates do not follow the typical construct of larger x and y coordinates being further north and east, respectively. Thus, the systems and methods herein may adjust Lat./Lon by optionally reversing the reference sequence at some level to achieve Geospatial Logic. It will be apparent for anyone skilled in the art of RTML mapping how to use the systems and methods herein with Lat/Lon as an underlying basis for the MLIDs. If Geospatial Logic is not desired for the SA and RSA for any given use case, the systems and methods for LIDs described here can be used to use LSDs for Lat/Lon in its native form.

Notwithstanding the foregoing, the MLID, RSA, and SA system do not require and in practice are not likely to require Geospatial Logic. The MLIDs provide sufficient, extremely abbreviated, and discrete Micro Location referencing to enable humans and machines to capture, curate, and communication Micro Location information without regard to Geospatial Logic. Further, the MLID for any given SA or RSAs may be unique and provide a precise and discrete Micro Location reference in that particular use with that particular SA and RSA. Since a major portion of the identification, referencing, communication, and use will be with or enhanced by machines, the machinations of Geospatial Logic are unlikely to be required or needed and as long as the MLIDs work to discretely identify the precise Micro Location for any given relevant SA.

When a machine or person is navigating inside a building, or even inside a specific room or building, the LPS systems and the MLIDs, RTML information and communication systems can be optimized for navigation inside the specific room, building, or relevant SA. In one aspect, the system may enable real-time, automated verification and updating of RTML information, MLIDs, through automated and manual correcting, feedback, enhancement, iterative adjustments and improvements of RTML information, Map Images through an iterative data feedback, correction, and AI enabled system whereby all users and devices can provide feedback to correct, adjust, and improve the RTML information about Micro Locations in real time to constantly and iteratively update and optimize the RTML information (collectively, the “Data Feedback System”).

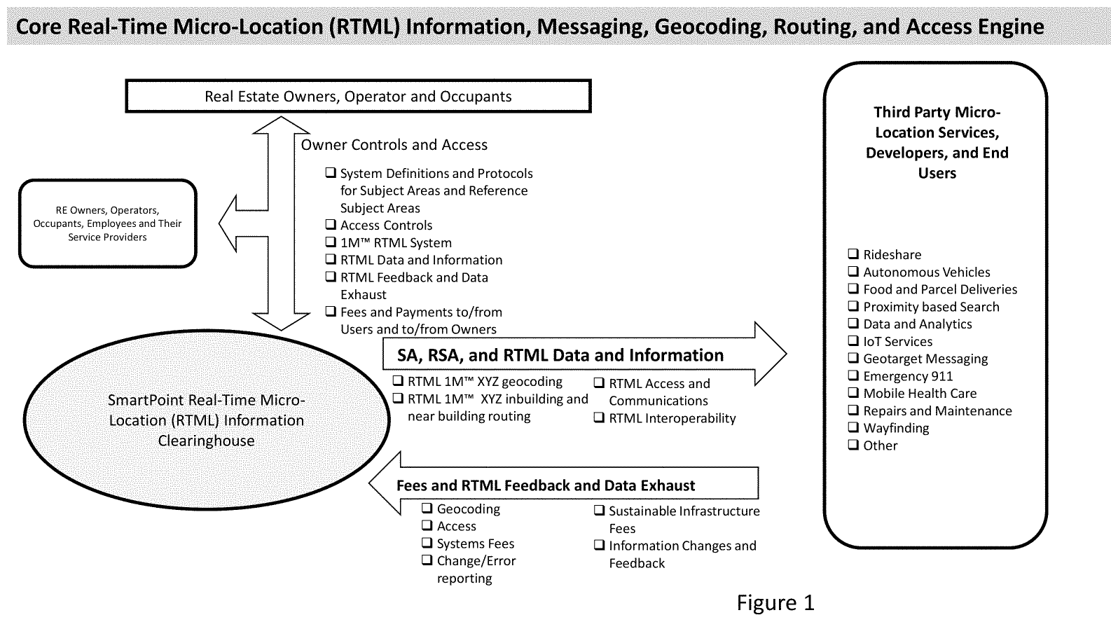

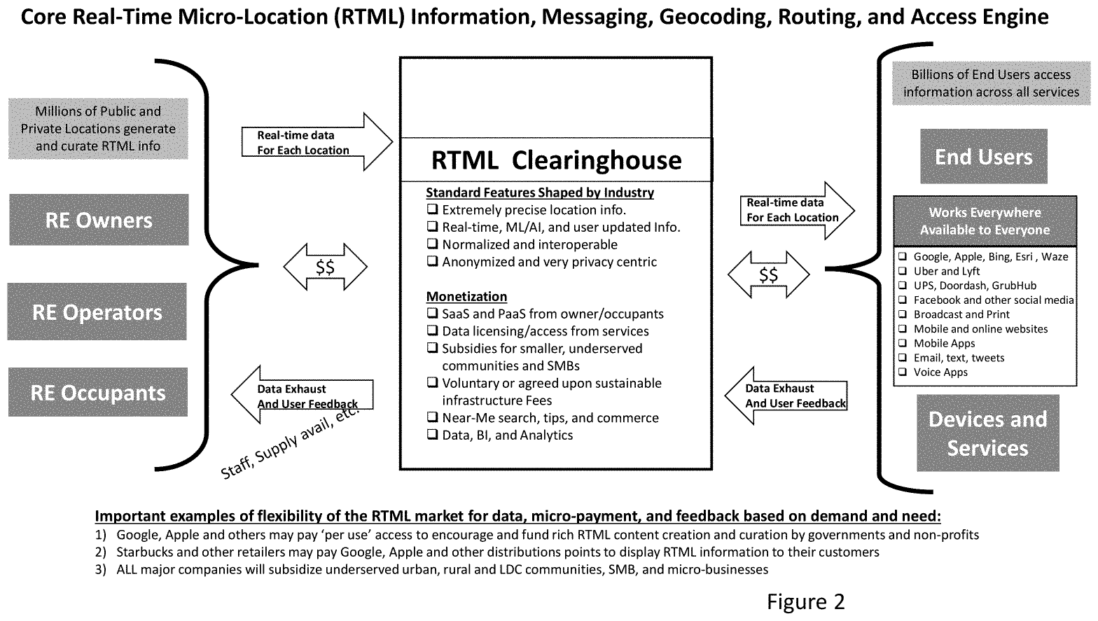

As indicated in FIGS. 1 and 2, the RTML system enables real-time changes and information distributed through a common registry/clearinghouse of SAs and MLIDs in a manner that uses various AI, ML, and other methods to both interpret and resolve such references and information. The system also accelerates the evolution and use of new, changing, or outdated or updated historical names, aliases, colloquialisms areas, and references through the RTML Data Feedback System.

One potential advantage of the system is the ability for all MLIDs, no matter how they are derived or the underlying basis of the MLIDs, to be recognized and used in virtually the same way and utilize a consistent look, feel, and structure notwithstanding the underlying RSA system that generates or supports the actual MLID. Thus, users and devices/machines can learn and utilize the information in a consistent and standard format and interface even though the underlying RTML references are based on different underlying methodologies and systems.

As an initial example of this concept, and as taught in more detail below, the 1 m location number of nnn.nnn can be determined in many ways, including:

a) the MLID may be based on a reference to a local RSA based on an xy, or xyz coordinate system like latitude longitude or UTM with various levels of precision;

b) the MLID may be random;

c) the MLID may be encrypted and/or randomized; and

d) the numbers may be sequential or otherwise structured or associated with an explicitly labeled location, such as a seat in a stadium, or any combination of systems and methods.

SAs and RSAs are not limited to the foregoing alternatives and may be based on unlimited structural options. For example, SAs and RSAs do not have to be one defined area or even contiguous areas. Coordinates do not have to be congruent with a global system or even parallel with latitude or Global Systems with north/south lines and may be canted or rotated in any direction. SAs may be of any shape or size, and RSAs may provide for MLIDs that are dynamic and encrypted for security or other purposes. Importantly, in many of the foregoing instances, the MLID will be presented to humans and machines in substantially the same manner with substantially the same interfaces in order to provide familiarity, simplicity, and potential ubiquity and interoperability across all devices and services. Thus, the MLID 273.992 may refer to an approximate 1 yard xy square area in a 2 dimensional coordinate system where 273 and 992 are derived by the coordinate system, or the MLID 273.992 might refer to a cubic or other area in space, or a specific room in a hierarchical RTML LPS system that incorporates building structure, floor plans, and other information. Nevertheless, the human and machine interface can advantageously use the same systems, input, output, and interfaces and familiar MLID format of 273.992 to identify and reference these various Micro Locations or to access and obtain information about, share, interface and communicate the MLID with others, devices, or even the referenced Micro Location associated with the SA, Micro Location or Device as a result of the systems and methods taught herein. The verbal communication of the MLID number at SoFi stadium can be structured and used by the system any number of different ways depending on the referenced or associated Micro Location, SA, RSA, and context or use. Thus, humans don't need to learn different SA and RSA systems for different locations and methodologies as they all present and are used the same way, and the MLID can be a universal reference for a precise Micro Location (and RTML information related to such location). Further, machine interfaces and data structures don't necessarily need to be programmed for numerous different SA and RSA systems.

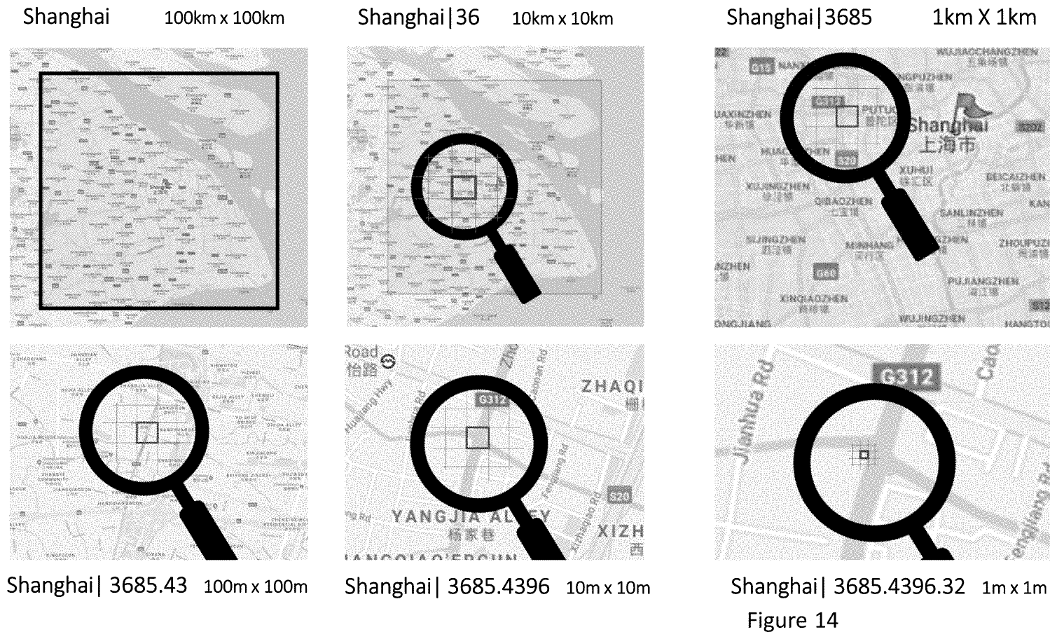

The RTML System can also be for larger areas. For example, in FIG. 14, a large SA for the city of Shanghai is illustrated such that MLIDs of 36, 3685, 3685.43, 3685.4396, and 3685.4396.32 reference discrete locations/areas of varying sizes, respectively, of 10×10-kilometers, 1×1-kilometers, 100×100-meters, 10×10-meters, and 1×1-meter, in or near the SA of Shanghai. This RSA is based on an egocentric 100×100-kilometer coordinate system, in order to achieve 10 billion unique 1-meter MLIDs for any Micro-Location in or near the RSA for Shanghai with only 10 digits. In most uses, however, the SA and RSA will be substantially smaller and thereby capable of achieving 1 meter precision with substantially few digits, often as few as 4 or 6 digits.

To further illustrate the efficacy of the MLIB system in this example, any 2, 4-, 6-, 8-, and 10-digit MLID will be unique and discrete within any extent of 10, 100, 1,000, and 10,000 meters, respectively. Thus, for any given MLID of nnn.nnn and this SA/RSA combination as illustrated in FIG. 14, the next closest identical MLID will be 1 kilometer, or approximately 0.61 miles away. Therefore, if the RTML system can derive the actual or determined SA and it is less than 1-kilometer in extent, the MLID in this example will be unique vis a vis that SA and RSA. Similarly, with an MLID of nn.nn in this SA and RSA, the MLID will be unique within 100 meters, which exceeds the extent of most buildings, houses, and other similar parcels and structures, or the extent of Legacy Street Addresses, which are the most likely determinants of SAs and RSAs.

RSAs do not have to be numeric and can utilize alpha numeric and even wholly alpha identifiers. For example, MLIDs may be structured in a AB.23 or 81.MT format, whether based on xy, hierarchical, assigned, or random references. In many uses, numeric SAs have distinct advantages over alpha numeric and alpha only MLIDs that are apparent for those skilled in the art.

Once a specific MLID is determined, the RTML system uses automated procedures, including AI and other processing logic and methods, to determine the MLID's actual geographic coordinates or other identifier by utilizing the locational context (typically an SA) or other contexts relevant to the user, use, and/or the general location or MLID. In addition to specifically designated SAs, possible sources of this locational context include: the identity and last known location of the user and/or the digital device(s) being used; data regarding the communications and connectivity of those device(s) with Wi-Fi-routers, cell towers, or other antennae (i.e. 5G, WAAS, etc.) with or without known locations; the identity of the recipient(s) or user(s) of the MLID and their digital device(s); the recent or historical locations of the user and recipient(s); their movements (via car, bike, etc.); other sources and surroundings (e.g., the communications channel, information contained in prior or subsequent verbal, text, image or other communications, any associated imagery, including photographic (visible or infrared spectrum), sound (ambient or otherwise), lidar, satellite, etc.

AI may be used to assimilate and interpret all available or determinable information to enable disambiguation, Micro Location, and determination the exact meaning of the MLID. For example, if the MLID is 347.919 in a standard RSA with 1 meter precision using USNG, then nearest identical MLIDs (i.e. 347.919) are approximately 1 kilometer away. Thus, if the system is capable of determining the general location of the user with at least 1 kilometer accuracy, the system can automatically and easily disambiguate the MLID to determine the exact geographic coordinate of the MLID. With MLIDs based on other RSA, the RTML system can nevertheless determine the exact geographic coordinate (and other information) associated with the Micro Location represented by the MLID. Concurrently, AI, AR, AVs and other automated procedures and/or methods can be used to capture and potentially augment information related to the user's SA, thus further defining that SA and any RSAs associated with it on real-time and ongoing basis. This background processing in the RTML system, continuously extends and improves the meaning of 1 m location numbers for all users and recipients as the system can iterate MLIDs, RSAs, SAs in real time.

MLIDs can be encrypted strings or words that are human readable and easy to communicate, but are not geospatially or otherwise interpretable in any way without the RTML-system-provided key or other methodology. In the case of encrypted MLIDs, only authorized persons may gain access to the MLID Micro Location or other ancillary information. MLIDs may be random or derived from existing spatial referencing systems, such as a campus or facility map. The geographic meanings of such alpha-numeric strings may also be dynamically updated on the RTML system. Thus, while the MLIDs are typically inherently geospatial and capable of human geospatial cognition, MLIDs can optionally be based on RSAs and other methodologies such that they are opaque geographically, except to authorized recipients and/or enquirers, via an RTML-supplied keys.

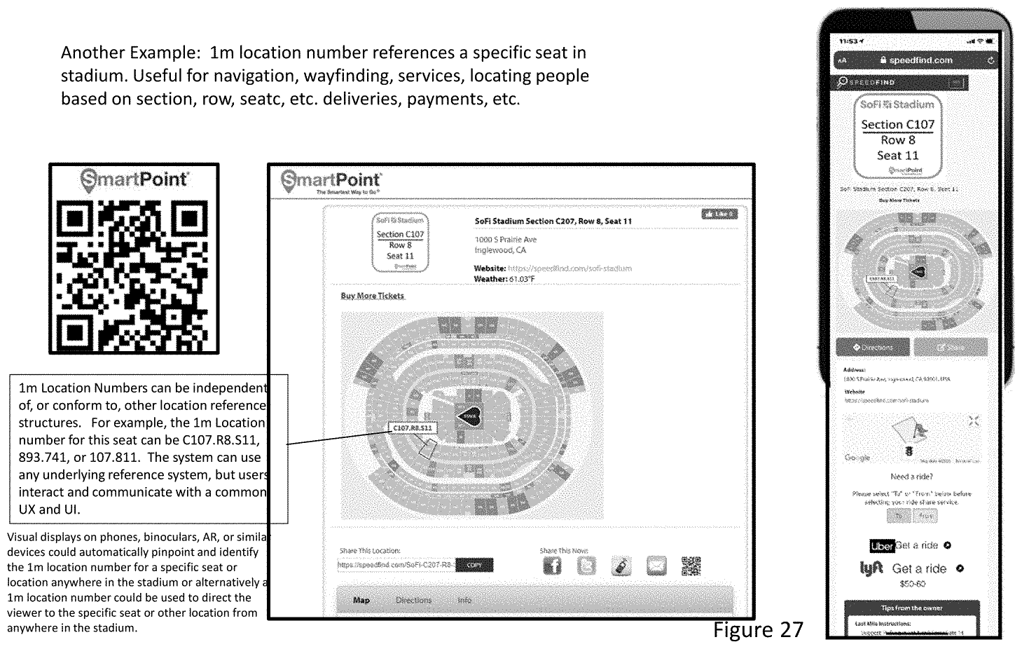

For example, in FIG. 27, a seat in a stadium at Section C107, Row 8, Seat 11 (the “Subject Seat”) might have an MLID of C107.8.11 or C1078.11, or even “JoesSeat”, to enable human readability and navigation and automatically provide certain information to any reader/user. From the stadium map, this could be translated to a 2D (xy) or 3D (xyz) RSA geographic coordinate that can be expressed as, for example, 241.909.32 for a specific ˜1 meter cube in the stadium's SA where the Subject Seat is located. The xy or xyz RTML coordinate MLID can also be randomly assigned and/or encrypted or designed to provide Geospatial Logic. Further, “JoesSeat” could reference a different seat for every event or even based upon the context of the usage or the user(s). Any of these georeferencing approaches could also require anyone looking to find, navigate to, obtain information about, or interact with JoesSeat to utilize the RTML servers or systems, present credentials as an authorized enquirer, to interpret the geographic location of the user's SoFi stadium seat. Thus, while anyone can quickly and easily see, know, input, write down, remember, and verbally communicate a particular location with an MLID, they cannot actually georeference the location without an RSA based on a known coordinate system and/or through authorized from the RTML system. Others who might see or hear or otherwise know such MLID would not have access to its geospatial meaning. Thus, persons can freely verbally communicate the MLID for the Subject Seat, and anyone overhearing the communication would not be able to use the MLID. Further, as is taught in U.S. Pat. Nos. 9,678,986, 9,928,252, and 10,565,239, the ‘owner’ of the SA and RSA (e.g. the stadium, the user, or others) can control access to the information through the RTML systems in real-time based on numerous conditions, contexts, etc. including the identity and the location of the devices or users.

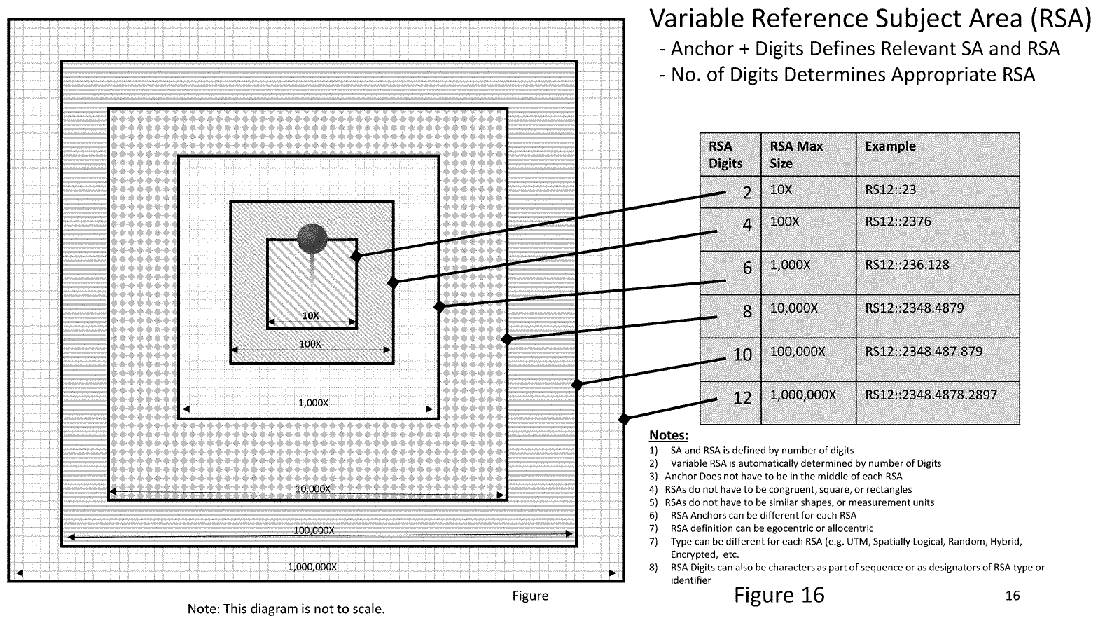

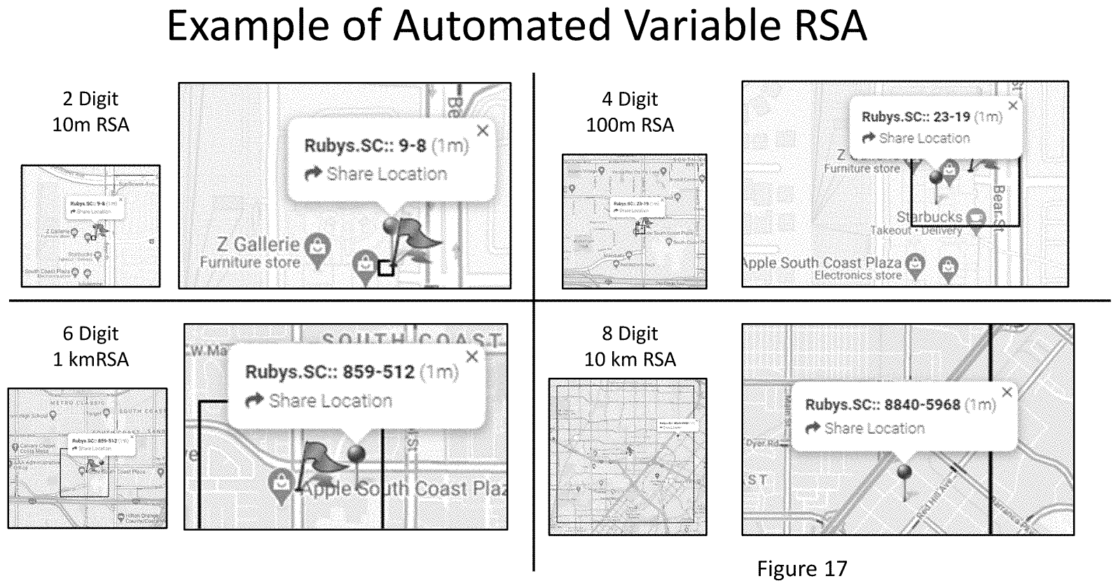

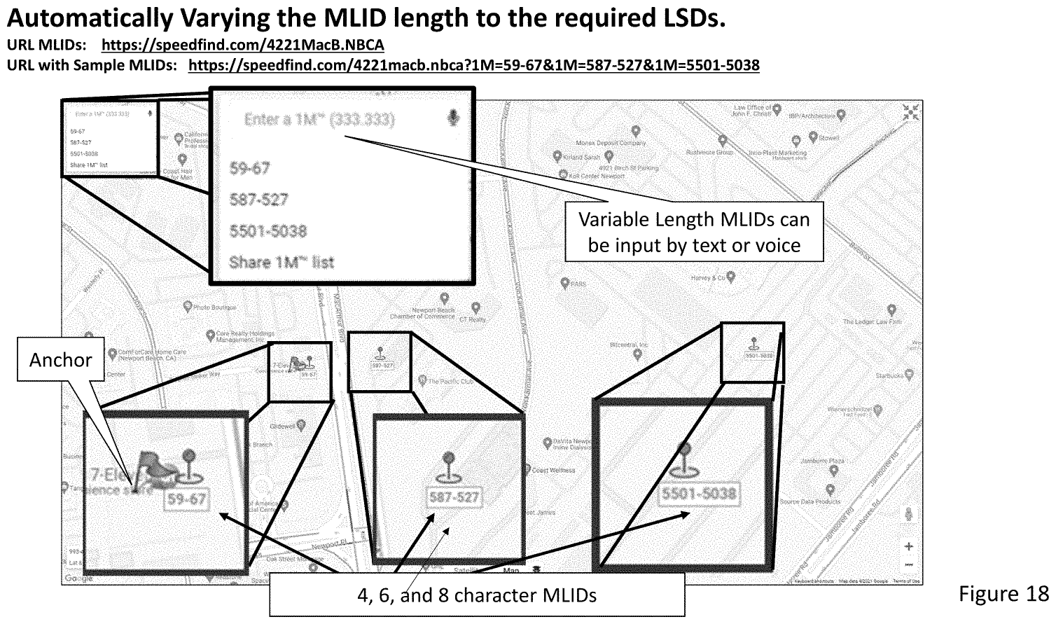

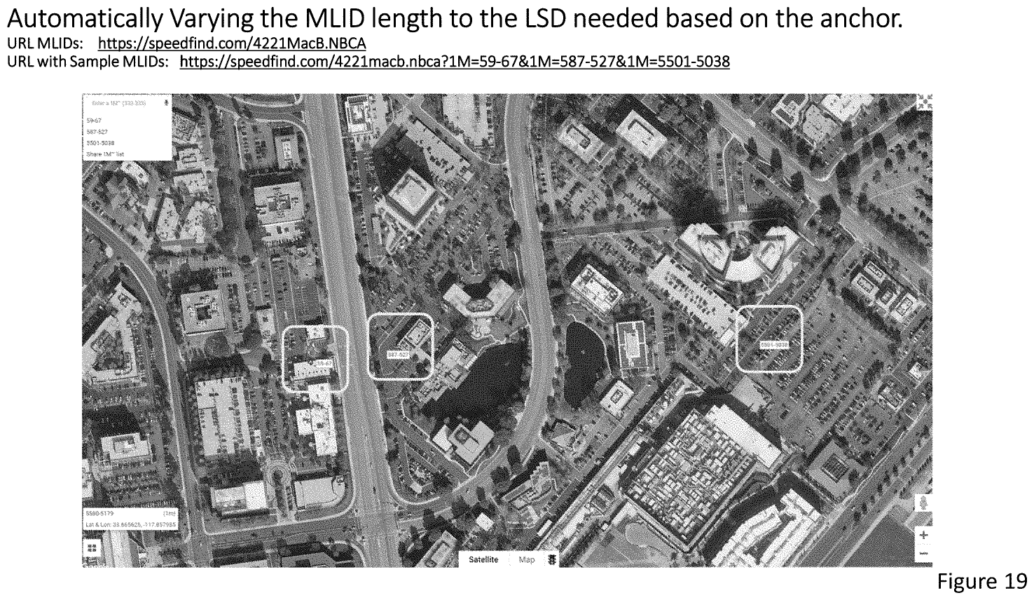

As evidenced in FIGS. 16-19, RSAs can be designed and assigned to use a variable number of digits based on the proximity of the Micro Location to any given anchor or reference point in an SA (Point X). For example, for any given point X (which can minimally define an SA in this example) the RSA can optionally define MLIDs for 1) any Micro Location Y within a 10×10-meter area centered around point X with only 2 digits, 2) any Micro Location beyond that 10×10-meter area but within a 100×100-meter area centered around point X with only 4 digits, 3) any Micro Location beyond that 100×100-meter area but within a 1×1-kilometer meter area centered around point X with only 6 digits, 4) for any Micro Location beyond that 1×1-kilometer area but within a 10×10-kilometer area centered around point X with 8 digits, and so on. This auto-scaling capability (Auto Scaling) enables an automated process with certain global RSAs whereby any point on earth can be identified relative to any other point on the Earth with variable length MLIDs based on the distance from the anchor point. Anchor points can be any known location, including a point related to Legacy Street Addresses. Thus, the Auto Scaling examples enable extremely short MLIDs relative to any point for the vast majority of Micro Location relevant to that point. For example, it is much more likely that users and machines will reference Micro Locations related to a house that are mostly within 100 meters of the house, and very unlikely that a user or machine will use an MLID for a Micro Location located 6 miles from the relevant anchor or SA. Thus, Auto Scaling enables the vast majority of MLIDs to be 4 or 6 digits, further simplifying the use and enhancing the efficacy of the short 4- and 6-digit MLIDs.

Concurrently, MLIDs can enhance the utility of AR, and AV and other video systems and devices by providing, displaying or otherwise communicating those MLIDs on screen or in heads-up displays to enable users to identify, see, remember, communicate verbally or otherwise use Micro Locations with third parties, importantly and optionally with encrypted MLIDs. For example, a person using a mobile phone or digital binoculars enabled with the functionality described herein could pinpoint a stadium seat of a friend at an event across the stadium, then see, use, and communicate verbally that seat or seat location through the MLID to others who could verbally input the MLID into another device to identify that Micro Location. Anyone can provide their Micro Location by communicating the MLID using their electronic device to another user's electronic device by first obtaining the MLID any number of ways, including reading it from their phone or other device, reading the MLID printed on a digital or printed ticket displayed on the seat, scanning or verbally inputting a QR or other code on the seat, or just reading it from any label or other display and then second, easily communicating and using the MLID reference to obtain Micro Location information via voice, link or other text, social media, email, group chat or through requests, communications or other interactions with voice services and devices such as Ski, Alexa, Google Voice, etc. to obtain the RTML location and information to the extent authorized.

For social media and similar uses, MLIDs provide simple, yet granular and precise location references, often intermediated by the RTML system through SAs and associated RSAs, for a variety of purposes, including obtaining information through Internet APIs, Web postings, chat rooms or chatbot conversations related to geographic locations, as well as commercial and location specific information, products, services, advertising, search results, and other services related to those Micro Locations. The system also enables AI-assisted personification of the MLIDs, SAs and associated RSAs. MLIDs can also be used for simplified designation of one or more Micro Locations or areas. Examples include a) LA48 or LA3981 for a predefined 10 km or 1 km square area that could also be aligned with USNG cell 10 km or 1 km areas/cell 48 or 3981; b) a specific hotel room or poolside spot at a hotel; c) a specific viewpoint at a park; or point along a river or beach that would otherwise be referenceable without long latitude longitude numbers or other coordinates; d) a specific building, floor, office, or other amenity at a building, e) a specific device, piece of equipment, or associated work or staging areas, f) a desk, workstation or open work space in an open work, work hoteling environment, or g) specific types of devices, services, or keywords related to a specific location. The MLID enables and facilitates AI enabled interactions with Micro Locations by referencing the MLID through chat bots and other methods. The entification and referencing of Micro Locations through the MLID enables and facilitates AI enabled big data structures, storage, curation and retrieval of Micro Location information through new, unique and efficient area location references that enable linear searches of geospatial data, which is much more efficient than non-linear geospatial data structures and searches.

MLIDs can be used for a myriad of location specific purposes, including but not limited to personal wayfinding, navigation, legacy and human driven or robotic/drone deliveries, games and gamification, tokens, collectibles and virtual ownership, asset management and maintenance, advertising, marketing and promotions, emergency services and other public safety and security systems.

The system may also include AI and/or other algorithms to determine and measure the veracity, precision, and efficacy of MLIDs, SAs and RSAs associated with various Micro Location or areas on a continuous basis. Using AI, ML, and NLP to recognize, interpret, enhance and curate MLIDs, SAs and RSAs via a crowd-sourced Data Feedback System. For example, the RTML System can track MLID usage through voice recognition. If users were typically historically referencing the SA SoFi Stadium for MLIDs in and around SoFi Stadium, upon a change in the name or sponsorships of the Stadium to McDonalds Stadium, the system could a) monitor and adjust and modify to recognize the SA name, “McDonalds Stadium”, b) use AI, ML, and NLP to learn over time that the SA McDonalds Stadium equated to the location or SA previously typically referred to and/or named SoFi Stadium, and/or c) learn the change from SoFi Stadium to McDonalds Stadium from numerous many uses of MLIDs and updating the relevant SAs/RSAs automatically.

There are countless sources of formal, informal, colloquial, and other geographic names and aliases for known places, which a data discovery subsystem will utilize to automatically define and/or reserve SAs. The Data Feedback System for ongoing crowdsourcing will assist in refining and maintaining SAs for such geographic places, both for the general population, and for specific persons or groups of persons as their usage is mined and processed with AI to extend and improve the RTML system over time.

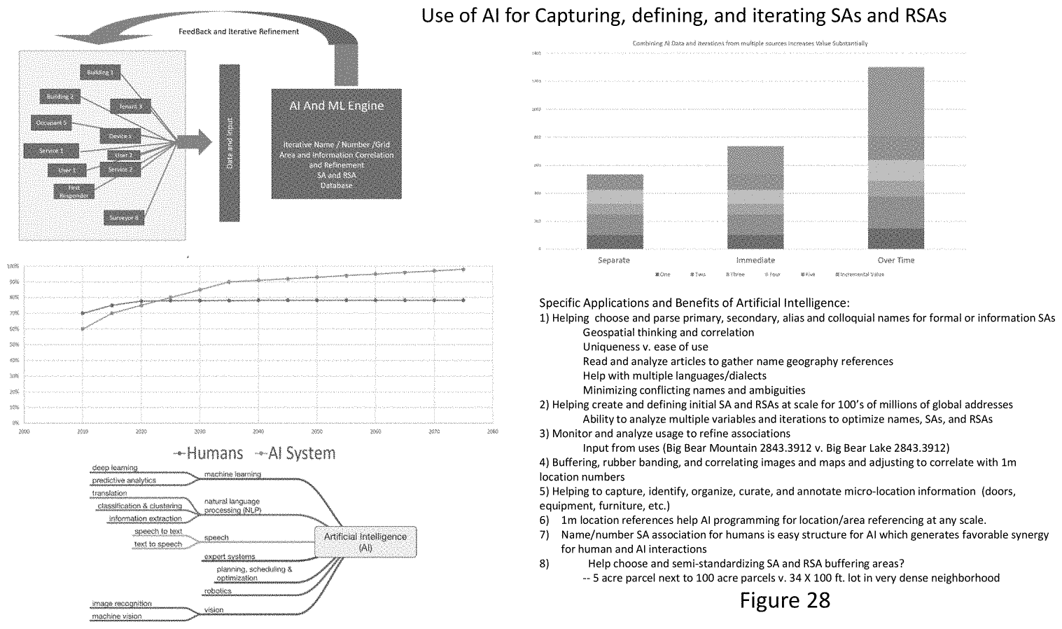

Artificial Intelligence and Machine Learning will play a significant role in creating, identifying, assigning, curating, iterating SAs, RSAs, and MLIDs. AI can be used to automatically generate, monitor, adjust, and distribute SAs, RSAs, and MLIDs and names and references for buildings, Legacy Street Addresses, cities, places, neighborhoods by analyzing known databases, social media posts and traffic, traditional print, broadcast, and other references, and new digital requests and usage of the RTML Systems. Some of these processes and systems are illustrated in FIG. 28 and include compiling, aggregating, and analyzing usage of both defined and preset SAs as well as generalized SA usage. RSAs can be created and adjusted at scale for millions of SA by applying AI analyses to usages, associated or other SA names, colloquial references, etc. For example, user references to specific street names/intersections or specific areas or businesses can be monitored. If a Holiday Inn Hotel changes its brand/flag to Ramada such that users are now referencing MLIDs near the Ramada Hotel, AI can adjust the preferred SA, RSA or even MLIDs to reflect that change. Similar, if users cease referring to the SA or associated MLIDs for the Holiday Inn for an extended time, AI may flag the location and/or perform further analysis to determine if the location has been permanently closed. AI can also be used to synchronize and populate Map Images to MLID references, especially MLIDs and RSAs based on 2D and 3D coordinate systems, assign and adjust names and descriptions to features in buildings (e.g., what is behind every door on every floor), and choosing and assigning preferred size and type of RSAs and buffering areas for given types or sizes of SAs, etc.

MLIDs can also be used as precise Micro Location references relative to any other known location without any specific reference to any specific SA. For example, in the context of specifically designated locations such as RideStop pickup and drop off locations, MLIDs can be used to identify and communicate the precise location of a rider or car associated with or near any such location. For example, User1's phone or other mobile device can identify and display User1's exact location near any RideStop location with a short MLID and enable User1 to verbally or otherwise communicate that location with a simple input, text, statement or other communication such as “My MLID is 7314”, or more simply “7314”. Since the context of the communication likely already has identified the specific RideStop or other pickup location relevant to the communication, the extremely short MLID enables RTML system to identify the exact Micro Location referenced by the MLID. Thus, the simple reference to 7314 is adequate to identify the precise Micro Location for these purposes. Of course, users always have the option to communicate the longer and more descriptive “I'm at RideStop Santa Clara Square 5, and my MLID is 7314,” or “RideStop Santa Clara Square 5 MLID 7314”. While the longer description is not necessary, it may become common with NLP and other voice services, essentially enabling for the first time ever users to effectively identify, pronounce, and communicate Micro Locations with brevity, clarity, and precision in a way that will transcend virtually all languages and dialects.

In addition to providing short, concise, and clear references to specific Micro Locations, MLIDs can also advantageously facilitate referencing of pre-defined and standardized area references for purposes of simplifying geospatial human interfaces, communications, and even cognition of spatial areas. This RTML system can also be optionally used to create and populate a series of preset areas for search, big data, BI, and GIS proximity determinations, either for initial searches in lieu of a hodge-podge of custom, bounded rectangles, and also for faster and more efficient and more precise distance, bearing, routing searches or calculations as described further below.

As a further example, the systems and methods herein may provide for simplified referencing of standard sized areas (e.g., LA 3821, LA3842, and KCMO3821 for identically sized 10×10 km areas), which would otherwise require 4 latitude longitude or other coordinate pairs for each reference. Similarly, LA384216, LA384426, and KCMO384216 can reference exact 1×1-kilometer areas, and so on for any desired extent. Such referencing systems can serve as an alternative to existing disparate and more or less randomized zip code shapes and sizes and provide a more structured, standardized and egalitarian method of compiling and organizing demographic areas in and around various cities or other areas. Here are some illustrative examples:

| MLID Reference | Lat/Lon Coordinates | |
|---|---|---|
| LA3821 | -117.88299 | 32.99399 |
| | -117.88299 | 32.99382 |
| | -117.88282 | 32.99399 |
| | -117.88282 | 32.99382 |
| LA3842 | -117.86319 | 32.93422 |
| | -117.86319 | 32.93405 |
| | -117.88602 | 32.93422 |
| | -117.88602 | 32.96405 |
| KCMO3821 | -94.70852 | 39.29734 |
| | -94.70852 | 39.29717 |
| | -117.88602 | 32.29734 |
| | -117.88602 | 32.29717 |

SAs, RSAs, and even MLIDs can be established, maintained, and accessed through a unified clearinghouse registry, blockchain or other distributed ledger, or through other virtual ownership and marketplaces for defining and using, owning, curating, selling, transferring, leasing, managing, and potentially monetizing usage through an RTML MLID Micro Location, information, and communications marketplace. Cities, counties, water, school, and utility or service districts and other political subdivisions, local associations, and others can create and/or claim ownership of relevant formally structured, named, and defined SAs to help provide, curate, and distribute the foundational infrastructure and core and other information for one or more SAs in or near their geographic boundaries. Such owners would be able to maintain, curate, and control SAs for the areas and/or sub-areas and some or all Micro Locations associated with the respective SAs, political subdivisions or other areas owned, managed, or controlled by them, as well as manage and monetize MLID and RTML information publishing and access/retrieval systems through micro-payment geocoding or other access, use, and/or data fees with micro-payments to/from users and applications developers or service providers to/from owners.

FIG. 2 illustrates various key parties and systems for owners of SA, RSAs, and/or MLIDs to be pay or be paid for the use of such RTML systems and related information, services, and communications with such systems for their SAs, RSAs, and MLIDs by end users or intermediaries, including map companies and addressing companies, rideshare, delivery companies, robotics and drone operators, advertisers, data aggregators, retailers, email, and other communication companies, etc. Because of the value of the SA, RSAs, and MLIDs to these uses, payments from end uses and these other parties may help fund the creation, curation, and management of SAs, RSAs, and MLIDs for underserved communities and economically challenged urban and rural communities, including small and micro-businesses and residential that are otherwise unable to effectively monetize the RTML information compared to more economically developed and robust communities, and the micro-payments (or other payments) to such owners from the users may subsidize or otherwise provide incentive for such communities to develop, maintain, and monetize such RTML systems in a more egalitarian RTMLS system.

Key aspects of the RTML clearinghouse outlined in FIGS. 1 and 2 include extremely precise (even infinitely precise if desired) RTML MLID references, use of real-time machine learning and artificial intelligence from ADs to enhance the RTML information, systems and methods to normalize and anonymize RTML information for interoperability and ubiquity, enhanced real-time privacy measures and systems, subsidies for smaller, underserved communities, businesses, and populations, enhanced commerce, voluntary or monetizable use or other based sustainability fees for the RTML system and/or sustainable infrastructure and services fees designed to offset the cost of the RTML system and/or other transit, mobility, delivery, and services, and advance business and societal intelligence and data.

MLIDs are particularly useful in areas that do not otherwise have roads, streets, buildings, or other landmarks. Examples include parks, beaches, lakes, rivers, large outdoor areas with variable tables, seating, etc. In these situations, MLIDs will greatly expedite Micro Location references and deliveries to such locations where customers, delivery personnel or devices (e.g., drones or other robotic delivery systems) otherwise have no way of determining and briefly and accurately communicating the precise location. In many cases, parties are required to have long conversations, often difficult and ineffective, to describe precise location verbally, find each other to explain their exact location with reference to visible landmarks, groups of people, or many other inefficient and ambiguous descriptions, and/or identify and walk to an identifiable landmark to expedite the delivery. These communications among humans are difficult, but they are virtually impossible with machines such as Siri, Alexa, and other NLP systems. Similarly, at large pool or outdoor areas (e.g., conventions centers, outdoor pools, or other gathering areas etc. in Las Vegas, theme parks, etc.) there are simply inadequate visible landmarks for a user to even know their precise location, much less communicate it to someone else or a Voice Enable system. Thus, MLIDs can greatly enhance both human and machine/device communications and activities. Even in parking lots in very close proximity to restaurants, stores, or other destinations, curbside and instore pickup, BOPIS (Buy Online, Pickup In Store) and other deliveries can be greatly facilitated by using MLIDs for either static, pre-designated pickup spots or for dynamic and variable parking spots near the destination, whether such MLIDs are assigned as static or determined by an xy, xyz, hybrid, or other system and method described herein.

MLIDs will be particularly helpful in 911 and other emergency services situations, whether based on preexisting SAs and RSAs, or temporary SAs and RSAs established or derived as needed for human, environmental, military or law enforcement, border security, containment, natural disasters or other emergencies. MLIDs can also assist in providing access and/or precise routing to patients or other emergency equipment, services, etc. and even access to information related to such patients, locations and equipment. MLIDs can also be associated with apartments, hotel rooms, and other buildings to provide a universal interface and common reference system across virtually all brands, buildings, and other structures to identify, locate, and navigate or wayfind to any such specific room or location as well as facilitating finding information about such room or location (e.g., features, devices, pictures, views, etc.). MLIDs can facilitate various app, voice, website, and other services and system (e.g., proximity focused search, advertising, secure payments, RTML information access, etc.) through simple and quick voice and other interfaces to expedite unambiguous designation of Micro Locations.

Building, floor, landscape, constructions, and other types of specifications, floorplans, blueprints and other systems can use and display MLIDs to enhance interoperability, precision, and to expedite and facilitate voice, digital, and other communications to/from workers, engineers, architects, delivery services, including referencing Micro Locations in, on, or around relevant properties, SAs, etc. MLIDs are helpful for construction projects for deliveries, establishing permanent or temporary staging or lay down areas, alternative project entry points, etc. The short MLID is particularly helpful for plans and specifications to replace cumbersome and non-standard Lat/Lon coordinates in plans and as built surveys, works orders, AI-enable AR, VR, and similar systems for referencing, documenting, and sharing Micro Locations in and around a construction project or site, and construction managers and other can adjust and refine MLID in real time as needed. Finally, the use of the MLIDs generate significant data on both usage and origins of use, particularly when MUD are used for deliveries and transit to projects and destinations. For ADs, MLIDs provide a simple common interface for managers and workers to designate pickup and drop-off locations, staging areas, etc. as well as documenting asset and resource placement on or off the project.

MLIDs can be added to any sign, post, wall, ceiling, or other item or device—from a digital billboard to an exit sign in a building or a trail sign in a park—to help users instantly know and communicate the exact Micro Location and/or access additional relevant information, products, and services related to the sign or Micro Location(s). MLIDs can be used to identify precise locations on a ski slope, bike path, lake, park, race or marathon course for any purpose or to find or provide or access additional relevant information for such precise locations. Further, MLIDs associated with such signs, lifts, etc. can be registered and used to create and navigate digital twins of all Micro Locations, places, buildings, projects, signs, lifts, etc. and to expedite access to relevant information digitally or by voice.

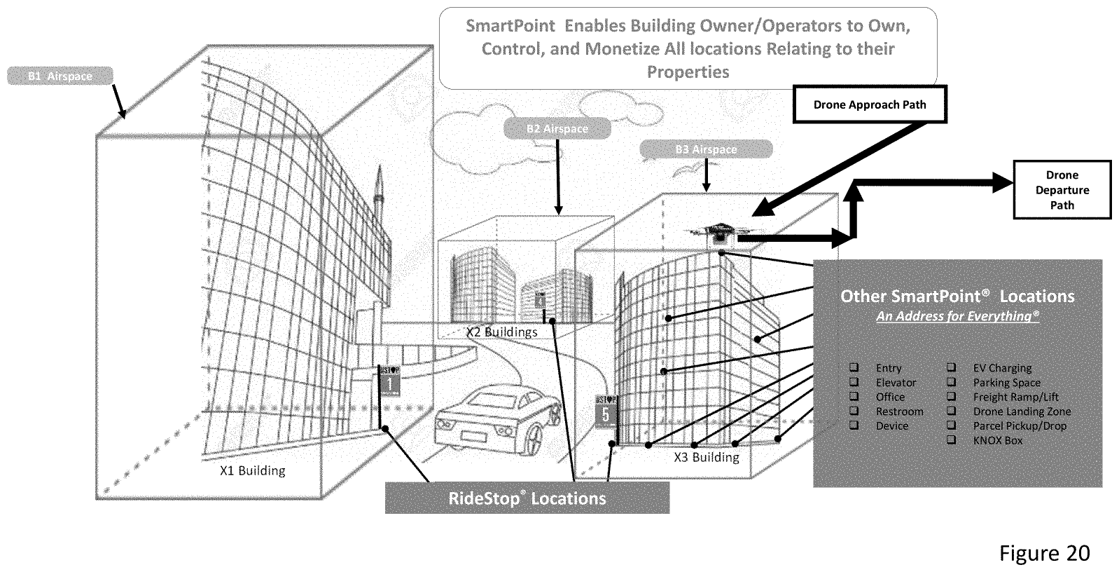

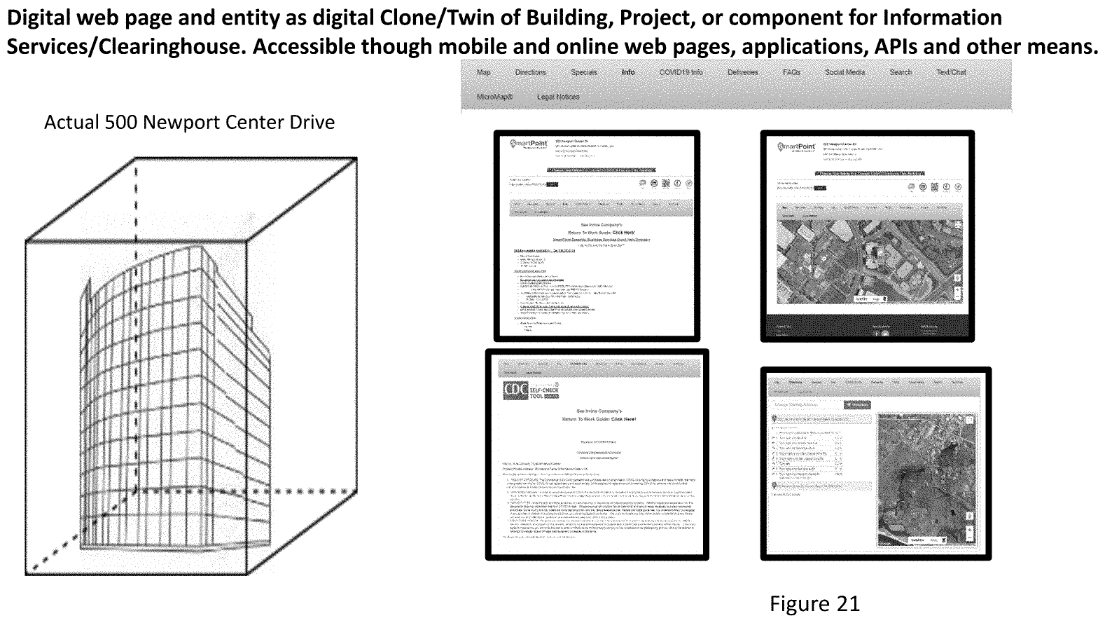

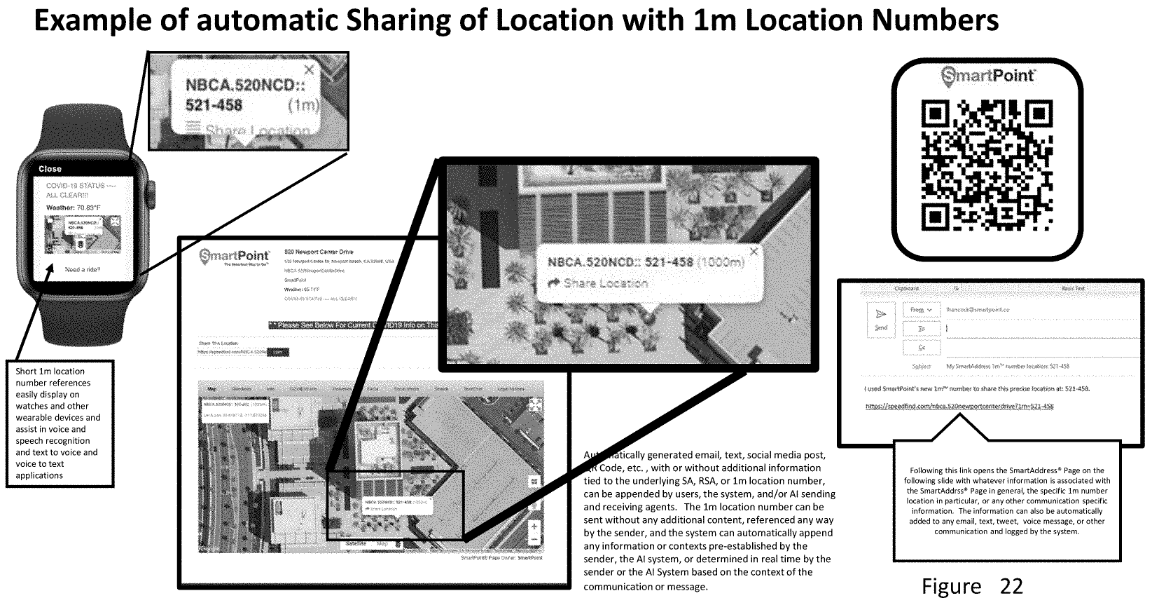

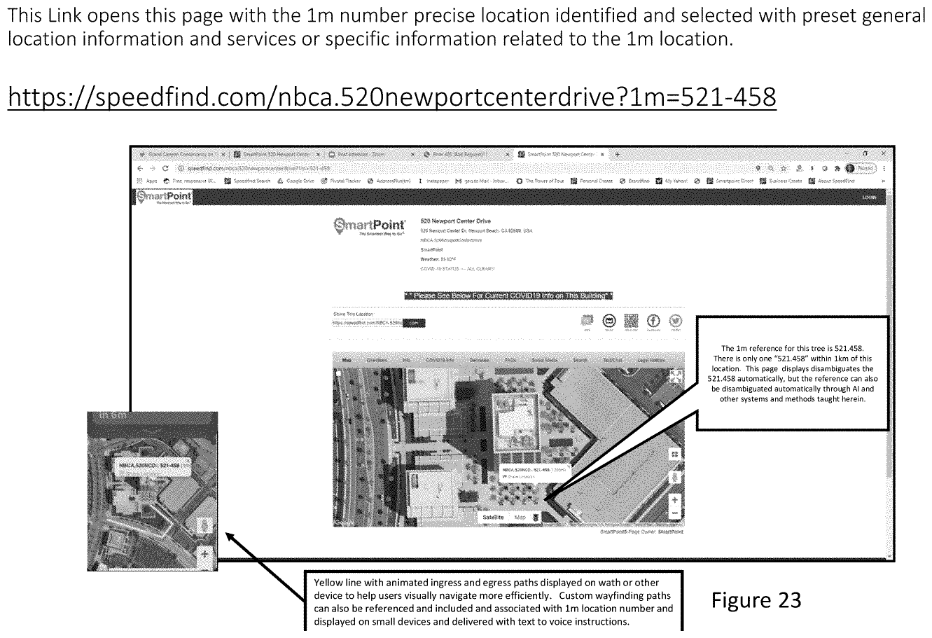

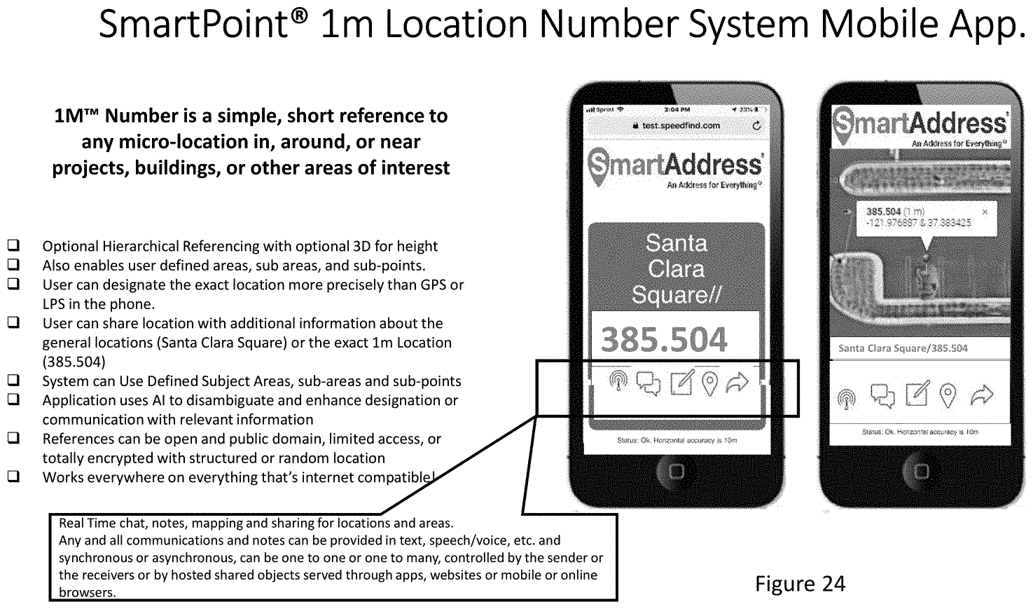

As indicated in FIGS. 20-24, MLIDs can be used by commercial, retail, industrial, and residential real estate owners, operators, and occupants to quickly capture, store, add to a document, spreadsheet or database, precise Micro Location references to assigned or unassigned Micro Locations in and around a property for utilities information (e.g., shut-off values, major components, etc.), landscaping (e.g., identifying specific trees, shrubs, sprinkler heads, or other precise locations for repair or service), etc. MLIDs can be limited to internal or individual use and encrypted or openly provided for sharing with others, including visitors, service providers, delivery services, drone and robotic ADs, emergency first responders, governmental or private utilities, etc. The brevity and precision of the MLIDs will 1) save users frustration, time, money, fuel/emissions, 2) enable much greater efficiency, accuracy, and precision, 3) reduce errors and wasted time, money, and bad results, and 4) provide a structured RTML framework for data collection and analytics. MLIDs can be easily used to define and monitor ingress and egress and other property or airspace access points and paths for ADs or people as well as to easily capture paths and points for wayfinding or defining, monitoring, and even monetizing approved entrances, visits, and paths. For example, airspace can be defined and referenced with MLIDs, SAs can be defined to include 3 dimensional areas, and RSAs can be defined in an x, y, and z format as indicated in FIG. 20, with z represented by MSL, AGL, floors or other measure. Required or optional inbound and outbound drone delivery or security paths can be easily defined, stored, and communicated by series of 3D MLIDs and points, and then aggregated into an MLID for the entire defined airspace. MLIDs, SAs, and RSAs usage can be monitored and monetized for efficacy and improvement, with monetization based on usage, compliance, tracking, etc. For example, a drone path could be defined as “Enter the SA for this property at 128.118, then proceed directly to 144.300 to the drop zone. After dropping the package, then exit directly to 183.214 before departing the SA (including airspace and a 3D RSA) for this property. Alternatively, the MLID could identify the totality of the airspace or designated path.

Correlating 2D and 3D geospatial references and coordinates across numerous map bases, aerial, drone, satellite and other images, floor plans, digital and printed maps, engineering drawings, plans and specifications, digital or analog pictures, PDFs, geoPDFs, AR, VR, and other video displays, floor plans, interior LiDAR point clouds, etc. (collectively, “Map Images”) to adjust for various scaling and projection errors is difficult if not impossible. There is currently no viable system for synchronizing and coordinate referencing of Micro Locations in a way that ensures that a Micro Location addressor reference is interoperable and consistent across multiple Map Images.

SAs, RSAs, and MLIDs may be used to help address this Map Image synchronization and interoperability problem and need by using them to correlate and/or synchronize separate 2D and 3D Map Images of various types. This can be achieved by automatically adjusting one or more known points on each such Map Image using the RSA and the SA for the area represented in the Map Image. To illustrate, assume MLIDs for the NE and SE corners of the building X are 34.12 and 22.14, respectively with an SA and RSA that provides 1 meter precision with a 4-digit MLID. The MLIDs for these Micro Locations can then be used to adjust disparate Map Images and synchronize RTML location referencing across separate Map Images so that the NE and SE corners of Building X is 34.12 and 22.14, respectively, on all Map Images. This synchronization will also effectively adjust the MLIDs for any other Micro Locations in the Map Images, effectively synchronizing all of the disparate Map Images into a near universal RTML referencing and mapping system. This enables MLIDs to provide interoperability across different Map Images as sort of a mapping lingua franca. Advantageous, because MLIDs are very short and often consist of a limited set of numeric characters, MLIDs also help usage across numerous languages and dialects for both spoken and written/visual word. These synchronizing and correlating adjustments for Map Images can be simplified for humans and/or can be automated for ADs by programs and AI to synchronize numerous underlying documents and digital databases. Some image-oriented document types such as geoPDFs have built-in 2D geospatial referencing, which can be discovered and synchronized on-the-fly. This can be accomplished manually or by using AI or other systems and methods taught herein.

SAs, RSAs, and MLIDs can be used to enhance privacy and obscure location referencing and associations between SAs and MLIDs by adopting RSA that provide various levels of encryption, limited access and password protection, etc. This can provide an additional level of protection and privacy for rideshare, deliveries, and other uses by designating exact pickup, drop off, or delivery locations using the MLID referenced to adjacent or nearby Legacy Street Addresses rather than the actual street address of the users.

For example, a user residing at 1234 Main Street can nevertheless designate the MLID for a pickup spot as 377.181 and an address of 1245 Main Street, or 377.181 near the corner of Main Street and Grand Avenue as the SA, thereby enabling all parties and devices to identify the exact pickup location without reference to the actual residence of the user. Similarly, MLIDs can be used in large apartment complexes or other large real estate campuses, projects, or developments to designate precise pickup, drop off, or delivery locations anywhere on or near the property and to disambiguate an exact apartment number or address. For example, the occupant of Apt. 24B at 1000 Main Street can designate the MLID Location number 910.183 without any reference to Apartment 24B, thereby ensuring that the delivery service (or perhaps just the delivery personnel) do not have access to the information of the exact residence of the user. Further, MLID can reference any nearby Micro Location, including a location in the lobby, near the entrance to the complex, a specific location near pool, side door or other area. The RTML System, MLIDs, SAs and RSAs can be designated and managed by co-owners to ensure that MLIDs are usable by all owners and/or their respective users without modification without permission of all or a portion of the co-owners, and the individual ownership of co-ownership can be accommodated by blockchain or other distributed ledgers, registries, or other systems to provide further validity, control, and availability of SAs, RSAs, and MLIDs. Whether the specific SA, RSA, or MLID relates to a specific Legacy Street Address or some other area, two or more parties (e.g., co-tenants in common, joint tenants, or a borrower and a lender) may jointly own and control the SAs and related RSAs and MLIDs. In a loan situation, the borrower, lender, and owner can designate all or a portion of property to be used as collateral for a loan or an appraisal or some other purpose, and they may irrevocably agree to designate a specifically defined SA and RSA for a property by a series of MLIDs associated to that specific SA or RSA that cannot be changed without the consent of all of the parties as they may agree at any point during the creation, curation, or maintenance of the jointly owned SAs, RSAs, or MLIDs. Such co-ownership of the MLIDs, SAs and RSAs can enable any party to share, use, enhance, or embellish with related information or data and information for short or long-term. Further, such joint ownership will can require both, multiple, a majority, or all parties to agree upon or consent to any such changes, actions, or even use.

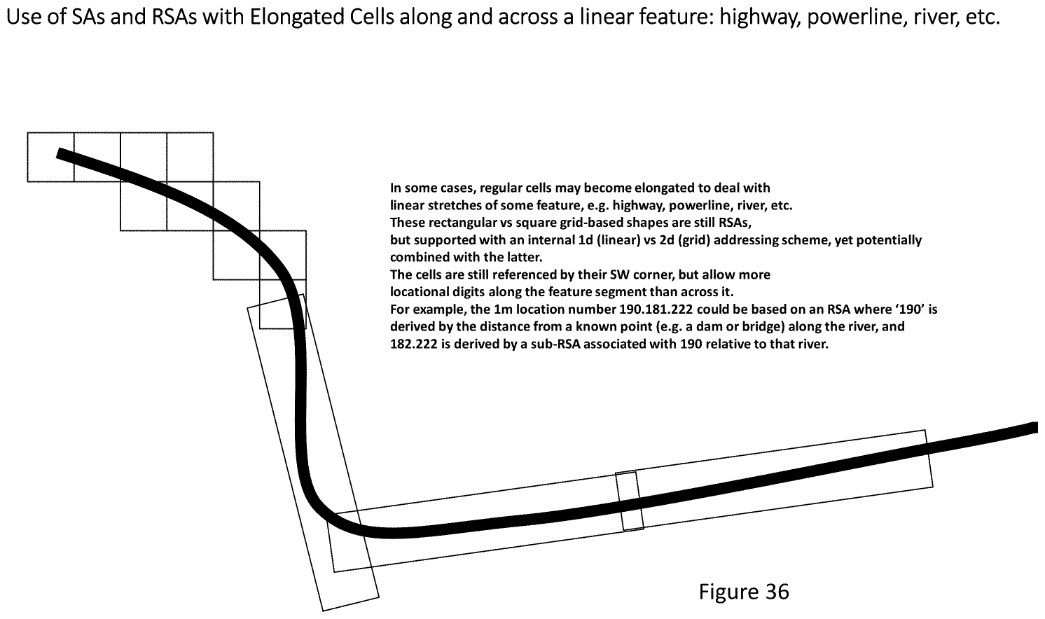

MLIDs can be defined and arranged in a hierarchically aligned and/or structured in nested manner with digital pairs as indicated in FIG. 14. This RSA structure facilitates proximity-based data structures, big data, and analytics. For example, for any given SA, the MLID may be implemented with nested tiles of increasing precision. With an MLID of 31.2811 in an SA that has an RSA congruent with UTM, “31” may reference a specific 100×100-meter UTM cell, “28” may reference a 10×10-meter cell inside the 31 100 m UTM cell, and “11” may reference a 1×1 meter area/point inside the 28 10 m UTM cell. This nested structure enables data structures and text searches for MLIDs (or data geospatially or otherwise referenced by such MLIDs) to be searched for MLID characteristics (e.g., all records with an MLID for this SA that has “31” in the 100 m cell reference, or all records that have 3128 in the 100 m and 10 m cell references). This enables geospatial data structures and search mechanics for easy and simple textual search and linear data structures of big data that is geotagged with the MLID reference and structure, which are vastly simpler than complex geospatial data structures and non-linear GIS search mechanisms. Thus, MLIDs may be used for storing, indexing, and searching geographic information, particularly Micro Location information associated with or near smaller areas, such as buildings, homes, apartments, residences, offices, etc., in a manner that substantially enhances the simplicity and efficacy of Micro Location data structures, searches, and references. Textual keys and searching are well established and more efficient than other types of non-linear and multi-dimensional geospatial searches. Further, SAs can also be created for existing locations, places, political subdivisions, areas (e.g., zip or postal codes, cities, districts, parks, and other boundaries), and RSAs can be used to further geospatially segment or reference Micro Locations and areas inside or such areas. In such event, MLIDs can be used to further identify Micro Locations or to segment data based on sub-areas inside the legacy areas and boundaries (e.g., zip or postal codes) in databases, pivot tables, and other data structures. Advantageously, the MLID references to sub-areas provide convenient, brief, and simple references to more granular areas within bigger areas, whether such references are structured or unstructured. FIGS. 29-32 include examples of using MLIDs for simple, single cell/field geospatial location identifiers in excel spreadsheets and other database structures. Finally, SAs can be designated along lines or elongated areas (e.g., a river, road, hiking or bike, trail, railroad, highway, etc.) as illustrated in FIG. 36. RSAs can be designed to enable MLIDs numbers to reference locations along such lines or elongated areas. For example, existing systems and processes can be used to more easily designate and analyze GIS data for MLID designated areas (e.g., the population and other demographics, number of households, fire hydrants, types of buildings, etc. in LA3823 or NYC3121 using MLIDs for areas to predefined standard areas of certain shapes and sizes to facilitate both location references but also comparative areas across numerous SAs). These systems can be used for simplified searches at varying levels of precision and/or area sizes by using RSAs with more digits (e.g., in one example LA3981 for an area of 1 kilometer and LA3981.39 or LA3981.3973 for an area of 100-meters and 10-meters, respectively.

The RTML Systems provide access to real-time data and information related to SAs, RSAs, and MLIDs through APIs and similar mechanisms. Further, MLIDs can be used in URLs strings and API requests to reference and/or request information or data related to Micro Locations referenced by the MLIDs in a manner that is more precise, simple, and accurate than traditional methods of including Lat/Lon xy coordinates in such strings and requests. Further, using MLIDs can enhance security, safety, and privacy by using encoded or encrypted MLIDs instead of universal understood and decodable Lat/Lon.

In addition to being too long and cumbersome for everyday use by everyday consumers, Lat/Lon computations are more precise than needed for most human-scale applications. Map Images seldom align perfectly with Lat/Lon based coordinates. For everyday purposes, there is a fundamental disconnect between Lat/Lon and the “flat earth”, xy or xyz, that humans experience and understand. SAs, RSAs, and MLIDs based on systems other than Lat/Lon better serve both humans and machines, that the spherical Lat/Lon geodesy system for people reference, mark, communicate, and depict locations on maps, visual and other displays, etc. as well as storing, retrieving, and searching for geospatial data in “big data” repositories.

RSAs for any given SA may also include alpha-numeric characters that have meaning for users (e.g., P31 or D47 for parking spot 31 or Door 47, respectively, regardless of how the numeric characters 31 or 47 are determined (e.g., assigned or from a 2D or 3D RSA coordinate). MLIDs can also include named locations, keywords, or other terms for any given SA, and such named locations, keywords, or other terms assigned for any given SA can reference specific Micro Locations or other things. Similarly, names for SAs may also include one or more numbers. Thus, if the ID or location associated with the name is Z9934, 9934 might be a part of the name for the SA and designate an area. Or 9934 could be the MLID Micro Location reference for the SA referenced as Z. Alpha numeric names and numbers may also be intertwined and used together. For example, Z9934.810.791 might utilize Z9934 as the name of the SA while 810.791 may be the MLID based on the specific xy or xyz coordinate system designated by the RSA. The owner or curator of the SA and RSA for this reference can select both the SA, the optional SA name if desired, and the RSA to determine the MLID.

Notwithstanding any of the foregoing determinations, users will be able to verbally or textually reference and use the SA and/or MLIDs and the RTML system will work with zero or nominal ambiguity. For example, a user within the Z9934 SA will be able to make a verbal request through Siri or others voice enabled devices or services by merely saying, “Hey Sir, I need food delivered in the next thirty minutes to 810.791. What are my options?” and the RTML system will enable the voice service to know the exact location of 810.791 (e.g., Conference room 472 on the 4^{th} Floor of a building a 18321 Main Street in Denver, Colo.)

Normalized SAs and RSAs will be provided for simplicity and interoperability across the world, but owners will be able to define SAs and RSAs for internal or external use for specific purposes or specific areas. Brands, businesses, college campuses, cities, building and project owners may name SAs consistently across all their geographies, or they may be customized. For example, the SA for every McDonalds may be MCDnnnn (where nnnn represents the pre-existing restaurant number or some other number associated with a bigger RSA) (e.g., a SA and RSA covering an entire 100×100-kilometer area around a major city similar to the example in FIG. 14), and McDonalds may always (or typically) define the RSA for their locations in the nn.nn format with a standard 100 m square RSA since McDonald restaurants and relevant areas rarely, if ever, exceed 100 meters in extent. So MCD1274.9182 may designate a precise MLID Micro Location with 1-meter precision near McDonald's restaurant number 1274.

It is important to note that SAs and RSAs can be adjusted from time to time by owners, or groups of owners, such that precise location references with the existing system will NOT change over time as land masses move. Currently, as land masses move as very precise latitude and longitude coordinate change with such movement. For example, the Lat/Lon in a specific datum for the corner of a building might be −117.123456789 and 32.123456789 today and −117.123456786 and 32.123456783 in 20 years. In contrast, a Micro Location with an MLID of LA1234.981.198 (with an standard 100 km RSA coordinate system that enables 981.198 to reference a precise 1 meter square location) will always retain the exact MLID for that exact Micro Location (981.198) because the anchor for the RSA for the SA (LA1234 will be adjusted to reflect any earth movements or shifts. This stability of MLIDs, together with the ability to adjust Map Images to the SA and RSA, combine to support that MLIDs could become a true lingua franca of GIS and Micro Locations across numerous and disparate maps, Map Images, languages, and dialects.

SAs and RSAs can also be created automatically or through scalable processes and procedures using AI and existing databases of buildings, parcels, places, legacy deliverable street addresses, apartments, Map Images, etc., to create primary or default SAs and optimal RSAs for any given Micro Location, Legacy Street Address, building, project, place, or other location. Street Addresses and parcel numbers can also be abbreviated at scale with AI and other algorithms with abbreviated discrete names/IDs for SAs, and AI can be used to optimize and automate the initial, proposed, or definitive designations of RSAs for millions of properties. By using AI and these systems, SAs and RSAs can be deployed for the approximately 180 million deliverable addresses in the United States today, and perhaps even for billions of known other known locations and sub-locations (e.g. streets, intersections, street lights, utility plants, switches, generators, etc.), many of which don't currently have any standard way of referencing their precise location other than the legacy street addresses (which are way too big and general) and perhaps long and cumbersome latitude and longitude coordinates, which are much more limited in capabilities and awkward, cumbersome and difficult for typical workers and consumers than short MLIDs.

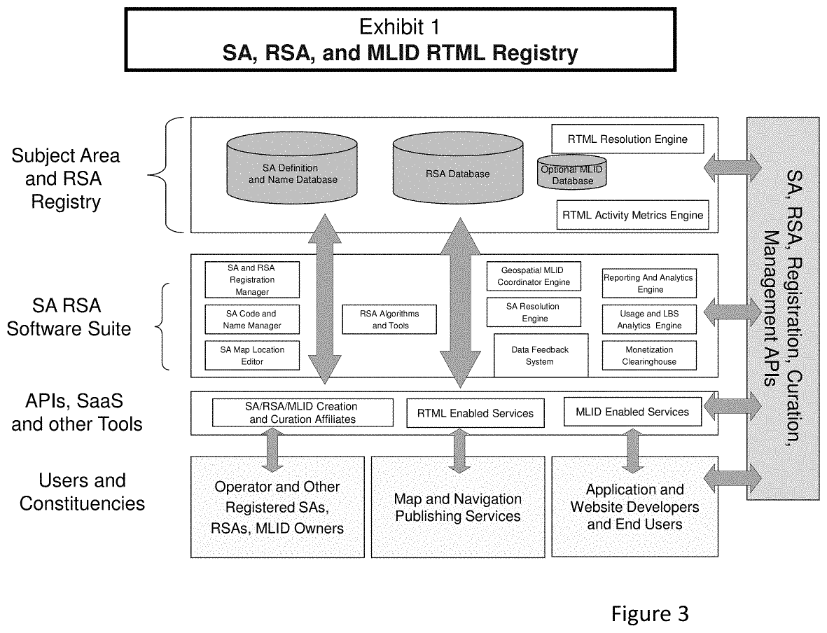

SA and RSA parameters for MLIDs and MLIDs can be defined and included in KML and/or GeoJSON or similar files, APIs, and computer functions to enable interoperability and efficient RTML referencing across various GIS systems. Further, the RTML system can utilize a registry of SA and associated RSAs and a clearinghouse enabling easy access to such SAs and RSAs and their parameters for others to access on demand, thereby always obtaining RTML information from such registry as evidenced in FIGS. 1-3. Alternatively, systems using such information internally by specific users can be periodically or synchronized on demand with the RTML registry to ensure that any changes in the SA or RSA are noted and used and/or appropriately adjusted. For example, if the RSA is based on standard UTM or USNG for any given SA, the system would designate USNG as the current RSA. However, if the RSA is based on another or custom system, the registry and/or KML or GeoJSON files would provide the parameters for such RSA, and these KML and GeoJSON files could also contain the RSA information for appropriately defined and associated SAs, RSAs, MLIDs, etc. for nearby or sub-locations in or around the primary SAs and RSAs.

MLIDs can also be accessed or associated with other addresses and location referencing systems, including SmartAddress Location IDs of various types as taught in U.S. Pat. Nos. 9,678,986, 9,928,252, and 10,565,239. Thus, an MLID can be associated with fixed or variable SAs tied to phone numbers, biometric attributes, domain name/URLs, social media handles, email addresses, or any other non-locational identifier (e.g., license plate, VIN, UUID, boat or plane registration, etc.) transformed into a location identifier as taught in these referenced patents. For example, User 1 could provide (verbally or automatically through the device) an MLID for USER1's precise Micro Location at a large convention center in Las Vegas to USER2 (or multiple users) during a phone conversation, and USER2 (or others) could then identify the precise Micro Location of USER1 in or near the convention center by associating with USER1's phone number as the ID for the underlying SA for the phone number with the RSA associated within the convention facility to identify the exact Micro Location of USER1. Similarly, a delivery service could utilize the MLID number for USER1 to expedite deliveries across a large convention or conference center whether or not the facility had any other type of space or location referencing system. Advantageously, the system and even multiple systems would perform exactly the same way for USER1 and USER2 (or others) without regard to whether the convention center was in Las Vegas, New Orleans, or any other location.

RTML system Users may be required or allowed to accept the terms and conditions of use for each specific SA and RSA, which can also automatically include terms and conditions associated with entering and visiting the underlying properties, buildings, venues, or other places associated with the SA or RSA. For example, uses may be required to acknowledge legal or other notices and/or agree to terms and conditions of access to the underly property, or acknowledge and agree to the terms of a temporary license to visit and enter the premises. A user using an MLID may be required to acknowledge receipt of certain notices and disclosures regarding the property and agree to certain terms and conditions of access before being authorized to use the MLID and associated navigation, wayfinding, information or related services, thereby establishing that user using the number have been advised of certain legal or other notices or information or have explicitly or tacitly agreed to certain terms and conditions of access and usages.

The RTML systems will capture information on usage, feedback from users via the Data Feedback Systems, and other information regarding SAs, RSAs, and MLIDs, including changes, error corrections, and other information on a real-time basis in order to obtain data to both enhance the efficiency of the system for subsequent users and to iterate with all users and uses to improve the system of associating MLIDs with SAs and RSAs. Such Data Feedback System can be used to adjust the Micro Location associated with SA and MLIDs in real-time by requiring or automating feedback from uses and devices using MLIDs. For example, if a non-coordinate or coordinate MLID is typically associated with the office suite of Owner1 and office of Employee X located in the office suite of Owner1 on SW corner of the 4^{th} floor of Building78 is used by a delivery service A (using ADs or persons) and ascertains that the MLID for the office of Employee X is in error or sub-optimal the delivery Service A can be required to report such information to the owner of the SA or other operator. Thus, if Owner1 and/or Employee X has recent moved to a new office on, for example, the NW corner of the 3^{rd} floor of Building78 (or Building79) and failed to adjust the MLID for the Owner1's office), the system can automatically adjust and iterate the location of Owner1 and/or Employee X to the new location so that future deliveries by all services using the same MLID will be directed to the new location of the office suite of Owner1 or the office of Employee X. Thus, the MLID for the Employee X's office remains the same, but the RSA and RTML System is adjusted to reflect the new location as a result of the Data Feedback System. This granular data exhaust and self-iteration and correction is a component of the user and data feedback loop for all users and will help the AI components and capabilities iterate, adjust and optimize SA, RSAs, and MLIDs for all users and uses and ongoing data analytics and business intelligence to constantly improve the system across all users, maps, and devices.

MLIDs may also be associated with permanent or temporary entry and access authorizations to locations and associated information. Thus, a typical MLID for a delivery to Home1 of 78.01 can be automatically enabled and/or disabled on specific dates and times controlled by the owner based on conditions, context, or any number of variables. Importantly, MLIDs are short and facilitate usage in links, QR Codes, texts, emails, verbal, broadcast and other communications and visualizations and can serve supplementally and significantly to enhance the use and communications of Micro Locations through general LIDs and names of locations taught in prior art with more granular and precise location references in and around the primary locations of the LIDs.

Named or unnamed SA, RSAs, and MLIDs can be owned and controlled by the RTML system operator or transferred, leased, or others assigned as property pursuant to the structure of the SAs, RSA, MLIDs and RTML Systems. These rights can be assigned and initially designated by one or more owners and then claimed and/or purchased by one or more owners to monetize through resale, monetization of usage, access to associated locations or location information or data or analytics associated with such usage, or in any other manner.

Internet browsers, applications, and other software programs (e.g., Excel, Google docs, Salesforce, PowerPoint, Word, navigation and mapping software applications and devices, ADs, etc.) can utilize MLIDs to synchronize disparate map bases, images, documents (e.g., PDFs), diagrams, floor plans, etc. that are viewed by users in order to ensure that MLIDs are accurate across all of such images. For example, browser extensions can be deployed that automatically display and/or adjust displayed content and/or MLIDs based on appropriate SA and RSA based on a number of contexts, content, user and usage to enable 1 m location numbers to be used across virtually all websites and content.

SAs, RSAs, and MLIDs can also be used for marketing and advertising purposes in order to precisely target advertising or similar messages to precise locations or destinations associated with SAs, MLIDs, and Micro Locations and small areas (e.g., building or offices, retail stores, skateparks, parks, outdoor areas in general or specific types, etc.). MLIDs can enable and assist proximity-based advertising, marketing, information distribution and other systems to more precisely provide or distribute information based on the exact Micro Location of the user, which will often mean at the building, office, or even employer level. Advertisers and other marketers can purchase access to MLIDs to display ad units relative to a specific Micro Location, exclusive or preferential rights to keywords or search terms for proximity-based searches relative to any SA or MLID. MLIDs can also support a paid search paradigm for every SA or MLID to extreme granularity and efficacy. For example, merchants in extremely close proximity or located within a given SA can bid on placement in search results for proximity-based searches near the given MLID or SA. Not only does this capability enable nearby restaurants or other merchants' access to nearby customers, but the SA and MLID further help make deliveries to that specific MLID more precise and efficient by providing the merchant RTML information related to deliveries to the MLID. Such RTML information could include, for example, expedited access to the exact location of the conference room, exact directions and wayfinding in the building, special access and contact information, precise delivery location (in the conference room, at the front desk on the floor, perhaps in the lobby of the building, or perhaps at another MLID for an area in the parking lot). Such information can also include billing information for the order related to the employer, employee, or visitor, which can further be integrated with conference room reservations systems so that orders can be automatically billed to the appropriate parties that may have reserved or are known to be using the room at the time of the order or delivery.

MLIDs can be used to standardize and normalize location references across all retail store channels by providing users MLIDs for precise Micro Locations for specific categories or types products, or even brands and/or specific products and SKUs for consumer referencing, finding and wayfinding to the products and services inside the store or other destination, together with detailed information, voice or visual directions, or other information to assist the user navigate directly to such location. MLID can be provided to a user in route to one or more stores and the MLID can be used to reference the exact pinpoint location inside the store to optimize the directions, wayfinding, and information provided to the user based on the precise location in the store for the desired product. For example, a user may be sent a promotional text message including a 4-digit numeric MLID (e.g., 3981) that indicate the precise 1-meter area inside a grocery, department, or other small, medium, large, or ‘big box’ retail Store X where a specific product or service is shelved. The user can then ask Siri, Alexa, or some other Voice service on a mobile electronic device for directions to Store X and MLID 3981, and the voice service can provide directions, Map Images, verbal instructions, and the like via the electronic device, not only to Store X, but to the exact parking lot entrance from the street, the optimal parking and entry into the building, and precise wayfinding to the precise MLID 3981, regardless of the underlying SA or RSA. The MLID can also be provided to a user inside the store looking for a specific brand, product or other item, and the user interface can provide the MLID in a consistent and familiar interface regardless of whether the MLID refers to a precise location in a huge lumber yard or a specific aisle and shelf in a small specialty store. The MLID can also be displayed on any Map Image to help the user navigate to the specific location of the product. In this example, MLIDs can be based on a 2D or 3D coordinate system or any other geospatial structure (e.g., a reference to an Aisle or distance down any Aisle). Advantageously, the user can hear, input, speak or otherwise designate the MLID for any product for any location at any store or destination regardless of the specific or unique aisle, shelf, or other organization references of any other given storage. Usage of MLIDs by specific users can be tracked and logged for various security, legal and other purposes, including verification of access and/or usage for various purposes.

Because of the brevity, compactness, and standardization of MLIDs, MLIDs are particularly well suited for identification and referencing by blind or otherwise physically challenged users. MLIDs are easily voiced by users or services and can effectively communicate the exact location to use with other devices and services. For example, blind persons could activate a localized voice broadcast of an MLID location on request to be able to know and communicate their exact location. Displays of MLIDs can be displayed or provided in braille or other methods of communications optimized for physically or mentally challenged users to enable such users to learn, communicate or obtain information about such Micro Locations.

The brevity, compactness, and standardization of MLIDs facilitates abbreviated location referencing for other impaired persons over virtually any devices, including small devices like watches, smart glasses, etc. For example, a speech impaired person could input a series of MLIDs into a navigation device for an electronic wheelchair with autonomous navigation capabilities. Brainwave or telepathic communications are more effective because of the ability to reduce the length of the MLID or other communication of a Micro Location to very few digits while providing substantial granularity and flexibility for various types of Micro Location references.

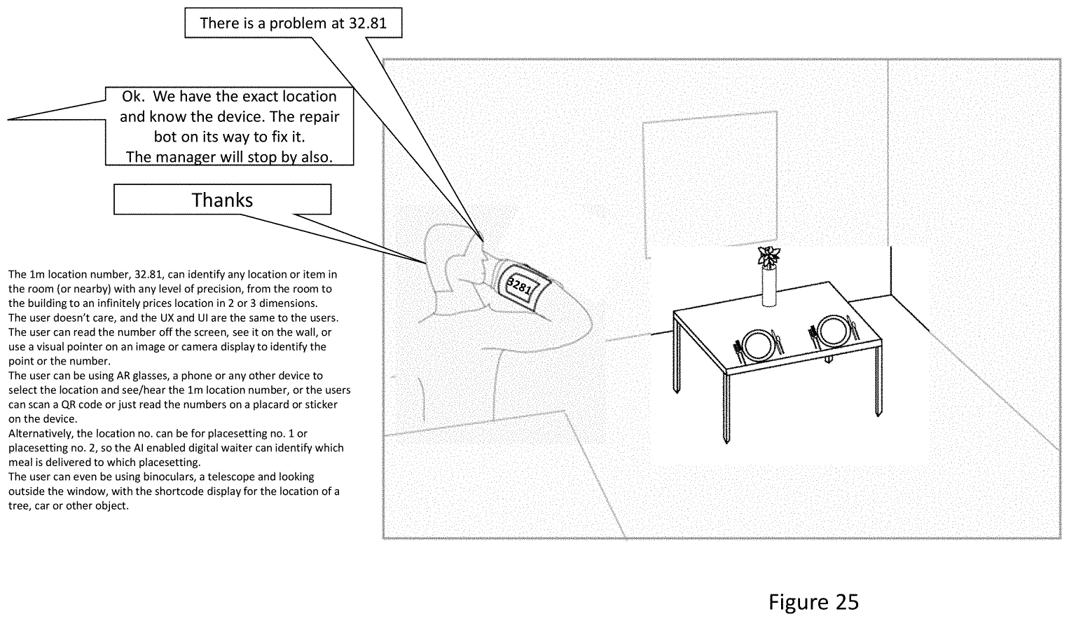

MLIDs can be displayed and used with wearable devices as illustrated in FIG. 25, where the MLID of 3825 identifies a specific location or item in or near a specific room. The MLID may be assigned to a device or item or represent an 2D or 3D area in or near the room. Either way, the user experience and interface are virtually identical, and users can view the location off the screen or device, if the MLID is assigned to a device or use a visual pointer to select and identify a Micro Location. Or the user may view the MLID for any Micro Location through an AR or VR headset, smart glasses, other display or scan a QR or other code on any item to identify, share location, or obtain or share information about the device or Micro Location. Alternatively, the MLID can reference the Micro Location for place setting no. 1 or place setting no. 2 so an AI-enabled digital waiter can identify which meal is delivered to which place. Further, the user can use binoculars, a telescope or other viewing device while looking inside or outside the window, with the MLID displayed for any location (the location or a tree, car, or other object).

SAs, RSAs, and MLIDs and related information in the RTML system and can also be customized and selective used for different users. For example, uses using and MLID to identify a conference or other room location in building may be provided different information customized for them. AI and other systems enable the RTML system to differentiate between users and provide different interfaces and optimal MLIDs for each user. For example, a high-level employee of the employer who controls the conference room, SA, RSA, and MLID may be provided with certain information and services customized to their likely needs, while most employees are provided different MLIDs, access, information, and services. Similarly, maintenance and service personnel are likely to need different MLIDs, access, information, and services relative to the serviceable assets at the location. Finally, a user who resides nearby may be presented with different MLIDs, information and services than a user who resides far away, who is much more likely to need a nearby hotel or rideshare to the airport.

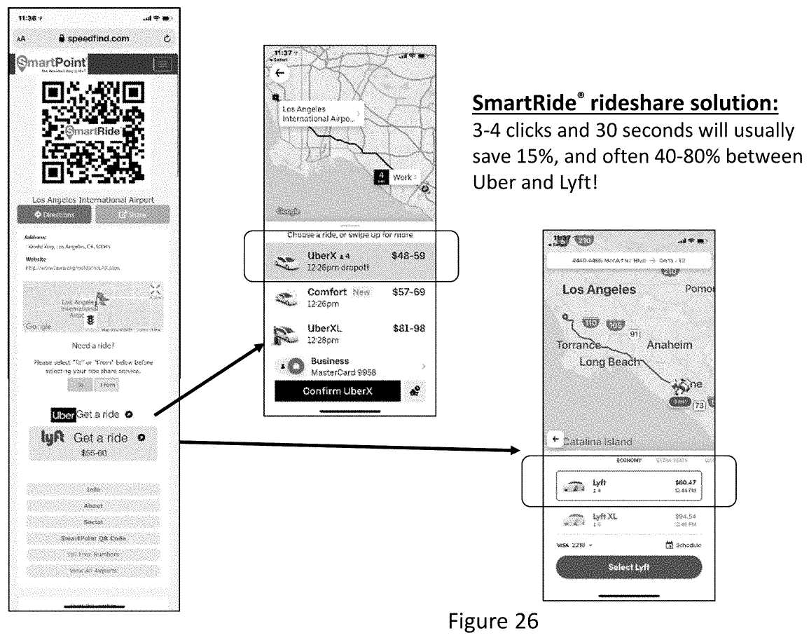

FIG. 26 shows an example of custom rideshare services that are facilitated by specific MLIDs used as an origin or destination. By providing exact pickup and drop-off points for a rideshare or autonomous vehicle service, MLIDs enable exact comparison of time, pricing, and other options to be compared side by side or in sequences that expedite the comparisons so users can select from a variety of alternative vendors. Similar to the use of MLIDs to access nearby merchants, MLIDs provide more granular location references, including alternatively preset pickup and drop off locations that enable exact price/time/product comparisons for any given ride and also make the fulfillment more efficient and expeditious by designating exact pickup locations. (E.g. I'm at 47.82 near 4872 Broad Street, where the MLID 47.82 identifies the exact location for the pickup spot.)

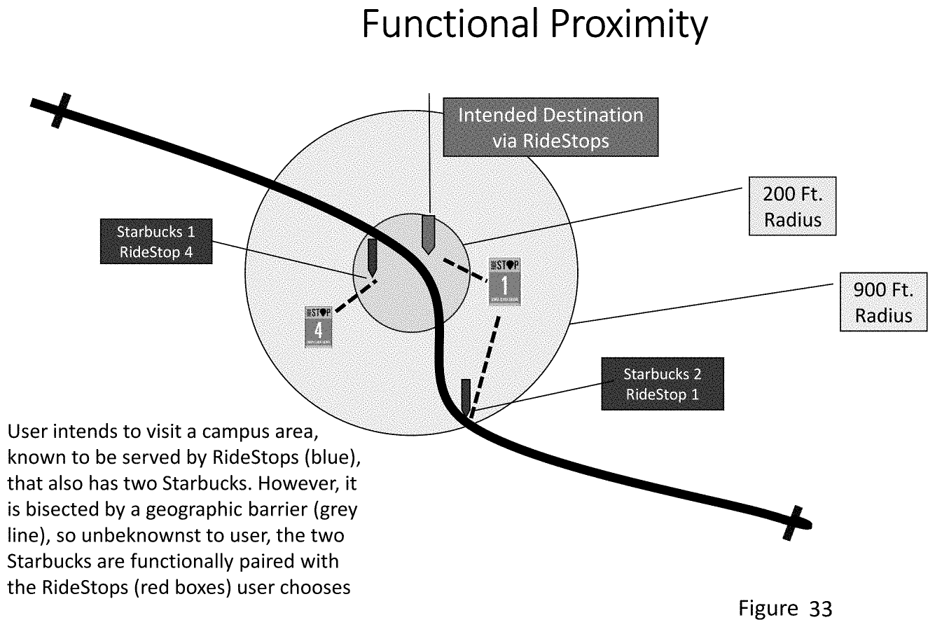

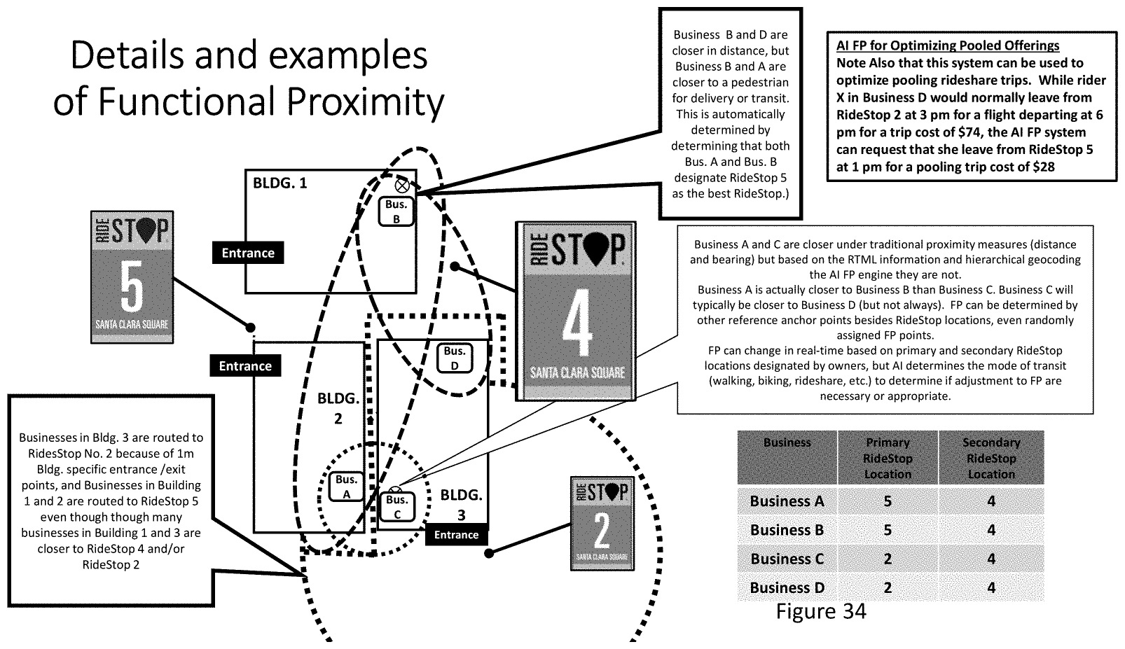

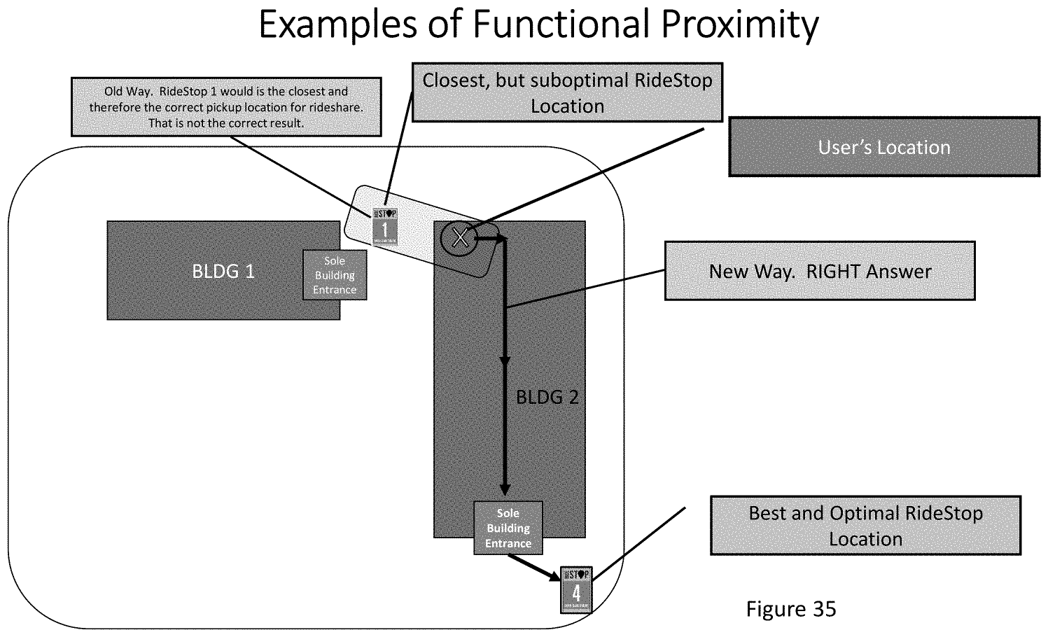

FIGS. 33-35 demonstrate Functional Proximity, which can be established, improved, and enhanced with SAs, RSAs, and MLDs and the RTML Systems, although such components and systems are not required. Proximity is defined by Webster's as “nearness in space, time, or relationship.” In the category of searching nearby and local search and local wayfinding, deliveries, rideshare pickups and drop-offs, and even everyday physical needs, proximity has most often been defined and determined by range and bearing. Most vehicle navigation systems take into account navigable transit options (primarily streets, roads and highways, etc.), non-navigable geographic barriers, (e.g., rivers, mountains, bridges, etc.), but often initial and ultimate proximity is still determined by distance, ‘as the crow flies’ from one point to another. This application of proximity is then refined with systems that compute driving, walking, or other transit times to build on more ‘relational proximity’. However, these systems have not been routinely applied for local positioning systems (“LPS”) inside buildings, projects, structures, etc., and for connections inside buildings to areas and locations inside or near such buildings. Thus, there is a need for a new type of proximity, which we refer to as Functional Proximity, which will typically be measured in time or possibly distance. However, the focus of Functional Proximity is not on range and bearing, but rather on paths, obstacles, wayfinding, and accessibility. Functional Proximity may also be based on one or more other factors, including safety, cost, hazards, exposure to elements, obstacles, wheelchairs, or other needs, etc. Functional Proximity will greatly enhance searches for products and services, deliveries, rideshare services, and other things. Functional Proximity for pedestrians may be different than other modes of transportation. Functional Proximity can be determined several ways, but the systems and methods herein may create a scalable system that can be applied with or without AI to determined Functional Proximity based on a series of waypoints (which can but are not required to be MLIDs or defined by RSAs) that are associated with relevant locations, or potentially logically or randomly distributed throughout relevant SAs or other areas by AI or otherwise enable systems to access locations using these Functional Proximity waypoints to determine Functional Proximity between one or more Micro Locations.

The most common waypoint may be a new type of standardized preset pickup and drop-off locations for rideshare and deliveries currently being deployed and known as RideStop®. While these RideStop location are typically optimized for rideshare and deliveries and may not provide the exact Functional Proximity for all Micro Locations near them, RideStop locations provide a highly scalable and effective way to obtain near optimal FP very quickly, easily, and efficiently. In one example, creators and owners of SAs, RSAs, MLIDs can select or determine the optimal RideStop location based upon the various paths, obstacles, and other factors to determine the true proximity or closeness (time, distance or some other measure) between one or more objects or locations. It is likely that many businesses and other locations will provide and publish their optimal RideStop locations (e.g. the SA SCSquare RideStop 5) for rideshare and other transit and wayfinding to or from their location(s). Functional Proximity for cyclists, pedestrians, wheelchairs, etc. can then be easily determined between any two locations by comparing their respective optimal and related RideStop locations. If two or more businesses share a primary RideStop location, they are likely closer together than two or more businesses that do not share a common primary RideStop location. The associated locations for Functional Proximity do not need to be RideStop locations, or even any other separately used locations, but can be a series of present or even digital Functional Proximity reference points. Functional Proximity enables searches for nearby businesses and other locations in close proximity to be easily determined at scale in real time without reference to xy, or even xyz proximity.

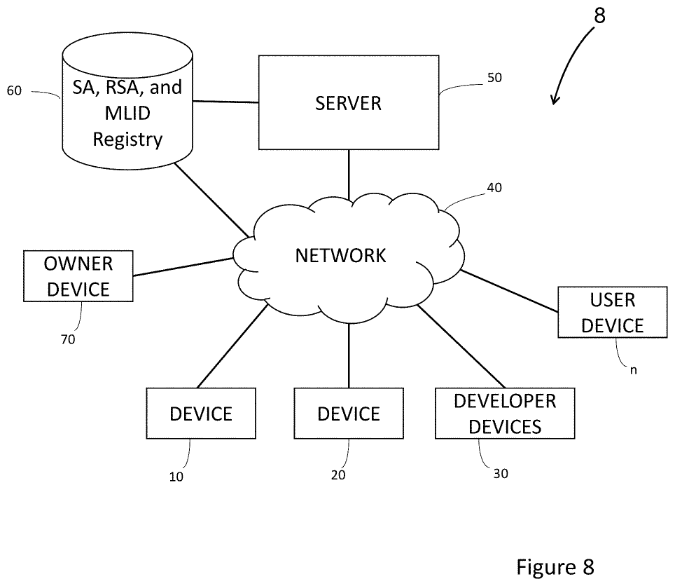

Turning to FIG. 8, an example of a system 8 is shown for performing the various methods and/or functions described herein. As shown, the system 8 includes various devices connected to a network 40, such as user devices 10, 20, 30, n, a server 50, and a MLID registry 60. In addition or alternatively, the system 8 may also include one or more owner electronic devices 70 (one shown for simplicity) connected to the network 40 for communicating with the server 50 and/or registry 60 via the network.

For example, client, servers, and other systems may be created for establishing, curating, controlling, searching, and/or otherwise using MLIDs by owners and/or users, according to the systems and methods described herein, including various devices connected to a network, such as various mobile and other user computers, phones, vehicle navigations systems, and other devices connected to a private or public network, including a wide area network (“WAN”), a local area network (“LAN”), an intranet, a wireless network, a short messaging service (“SMS”), or a telephony network. For example, any such network may incorporate several different types of networks including a WAN, a LAN, and/or a wireless network. One such network including multiple different types of networks is the Internet.

Any of the electronic devices, e.g., the user devices 10-n, owner devices 70, and/or other devices implementing the system, may be a desktop computer, a laptop computer, a mobile or cellular telephone, a personal digital assistant (e.g., a Palm Pilot device, Blackberry device, and the like), glasses or other wearable computing devices, interactive television, a vehicle or portable navigation system, a kiosk, a lobby or elevator monitor, or other electronic device, capable of communicating via any such network. Generally, the electronic devices 10-n or 70 may include one or more processors, memory and/or storage devices, communication interfaces, and/or User interfaces, e.g., a display, keyboard, mouse, and other types of interactive interfaces (voice, motion, etc.). For example, the interfaces may include one or more input devices, such as a microphone, keyboard, touchscreen, camera, and the like, and one or more output devices, such as a display, speaker, light indicators, and the like.

The devices 10-n or 70 may interact with the server 50 and/or MLID Registry 60, e.g., by inputting MLIDs or other requests that may result in the inclusion of MLIDs in the information or files provided or communicated or other information related to items of interest associated with the MLIDs as described elsewhere herein.

The MLID Registry and database, clearinghouse, access and control, accounting and other modules may include one or more hardware-based components and/or software-based modules for performing the various functions related to the methods performed, as described elsewhere herein. Multiple interoperable or distinct MLID Registries and modules may be used for various specific purposes or specific or certain types of MLIDs.

For example, the server 50 may include one or more computer systems, e.g., servers, communicating with one or more databases, e.g., including one or more processors, memory and/or storage devices, and communication interfaces for communicating via the network 40, e.g., with users 10-n and/or other parties involved in the methods performed by the system 8.

The server 50 may include one or more hardware-based components and/or software-based modules for performing the various functions related to the methods performed, as described elsewhere herein. Although only one server 50 is shown, it will be appreciated that multiple servers (not shown) may be provided at the same or different locations that operate cooperatively to perform the functions described herein. The hardware and/or other components of the server 50 and/or other components of the system may be similar to those disclosed in U.S. Pat. Nos. 5,839,088, 8,935,220, and 10, 229,216, the entire disclosures of which are expressly incorporated by reference elsewhere herein.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

1. A system for identifying and referencing micro-locations with one of one or more alphanumeric shortcode micro-location identifiers used for human to human, human to device, and device to device communications, input, output and displays, comprising:
an electronic device comprising a user interface and a display; and
one or more processors configured to:
enable a user to enter, input, speak, see, select, or communicate, using the user interface of the electronic device, one or more micro-location identifiers with reference to a subject area;
determine the subject area and assigned reference subject area; and
resolve and use the micro-location identifier with reference to a subject area.

2. The system of claim 1, wherein the system determines the number of digits contained in the micro-location identifier based on a subject area and reference subject area and determined by reference to at least one of: a) displaying or using a portion of the least significant digits based on a pre-selected level of precision of a global allocentric two-dimensional coordinate system such as latitude and longitude, Universal Transverse Mercator, Military Grid Reference, or United States National Grid; b) displaying or using a portion of the least significant digits based on a pre-selected level of precision of a global allocentric three-dimensional coordinate system such as Earth-centered, Earth-fixed (ECEF) or the geocentric coordinate system; c) displaying or using a portion of the least significant digits of such coordinates based on a pre-selected level of precision of an egocentric two or three dimensional coordinate system based on the size of the subject area; d) assigning specific micro-location identifiers for one or more specific micro-locations with reference to the subject area; e) one of the foregoing encrypted in a manner that it cannot be used without an encryption key; f) random micro-location identifiers in a manner that it cannot be used without an encryption key; and g) a hybrid combination of the foregoing for the subject area and reference subject area.

3. The system of claim 1, wherein the one or more processors are configured to determine one or more of the subject area, the assigned reference subject area, or micro-location identifiers from a registry of pre-defined subject areas, assigned reference subject areas, or micro-location identifiers determined by reference to at least one of: a) a two- or three-dimensional subject area determined by reference to an existing real estate parcel, park, block, development, campus, combination of buildings, project, building, residence, apartment or other structure or sub-structure; b) a two-dimensional subject area; c) a three-dimensional subject area, and d) whether or not the assigned reference subject area enables the micro-location identifiers to incorporate geospatial logic.

4. The system of claim 1, wherein the one or more processors determine the subject area and assigned reference subject area based on a generalized name of the subject area or other general location provided by a user on a use-by-use basis determined by one or both of artificial intelligence and an algorithm using natural language and cognition processing.

5. The system of claim 1, wherein the user interface is configured to allow input of the micro location identifiers by the user based on at least one of text, voice, selection, brain communication interfaces, scanning, and hyperlink.

6. The system of claim 1, wherein the one or more processors are configured to use or include additional information, search results, or services related to the one or more micro-locations identified by the micro-location identifiers determined with reference to the subject area in response to any input or communication related to the one or more micro-location identifiers.

7. The system of claim 1, wherein the one or more processors are configured to disambiguate or determine one or more of the one or more micro-location identifiers or the subject area by using information provided, known, or determinable by one of a sending or receiving electronic device or remote servers, including one of a) general location or other information related to the one or more of the micro-location identifiers or subject area, b) the identity of the user, and c) user and device generated contextual information related to one of the user, use, or general location or other information related to the user or use.

8. The system of claim 1, wherein the one or more processors are configured to display one or more of the micro-location identifiers or micro-locations on digital maps, virtual, augmented reality, and other displays, aerial, satellite, and other images, drawings, floorplans, schematics in order to identify the subject micro-location identifiers and associated micro-locations based on at lease of a) user selection of a micro-location or b) user input of a micro-location identifier.

9. The system of claim 1, wherein each of the one or more micro location identifiers consists of one of a) one to ten numeric or alphanumeric characters organized and structured in a two-dimensional xy or three-dimensional xyz format; b) one to ten numeric or alphanumeric characters organized and structured in a hierarchical, nested format; c) one to ten numeric or alphanumeric randomized characters; or d) one to ten numeric or alphanumeric characters organized and structured in a hybrid xy, xyz, hierarchical/nested, or random format.

10. The system of claim 1, wherein the micro-location identifier consists of one of: a) a pair of 1-meter and 10-meter least significant digits derived from the 1-meter Universal Transverse Mercator coordinate pairs for the micro-location, b) a pair of 1-meter, 10-meter, and 100-meter least significant digits derived from the 1-meter Universal Transverse Mercator coordinate pairs for the micro-location, c) a pair of 1-meter, 10-meter, 100-meter, and 1,000-meter least significant digits derived from the 1-meter Universal Transverse Mercator coordinate pairs for the micro-location, d) a pair of 1-meter, 10-meter, 100-meter, 1,000-meter, and 10,000-meter least significant digits derived from the 1-meter Universal Transverse Mercator coordinate pairs for the micro-location, and e) one of the foregoing automatically determined to be the least number of pairs required based on the distance of the micro-location from the anchor established by the reference subject area for the subject area.

11. A method for identifying and referencing micro-locations with one of one or more alphanumeric shortcode micro-location identifiers used for human to human, human to device, and device to device communications, input, output and displays, the method comprising:
enabling a user to enter, input, speak, see, select, or communicate using an interface of an electronic device, one or more micro-location identifiers with reference to a subject area;
determining the subject area and assigned reference subject area; and
whereupon one or more processors resolve and use the micro-location identifier with reference to a subject area.

12. The method of claim 11, wherein the micro-location identifier is based on a subject area and a reference subject area and determined by reference to at least one of: a) displaying a portion of the least significant digits based on a pre-selected level of precision of a global allocentric two-dimensional coordinate system such as latitude and longitude, Universal Transverse Mercator, Military Grid Reference, or United States National Grid; b) displaying or using a portion of the least significant digits based on a pre-selected level of precision of a global allocentric three-dimensional coordinate system such as Earth-centered, Earth-fixed (ECEF) or the geocentric coordinate system; c) displaying a portion of the least significant digits based on a pre-selected level of precision of an egocentric two or three dimensional coordinate system based on the size of the subject area; d) assigning specific micro-location identifiers for one or more specific micro-locations with reference to the subject area; e) and one of the foregoing encrypted in a manner that it cannot be used without an encryption key; f) random micro-location identifiers in a manner that it cannot be used without an encryption key; and g) a hybrid combination of the foregoing reference subject area.

13. The method of claim 11, wherein the subject area is determined by the one or more processors by at least one of: a) a predefined subject area determined by reference to a two-dimensional area; b) a predefined subject area determined by reference to a three-dimensional area; and c) a predefined two- or three-dimensional subject area determined by reference to an existing real estate parcel, park, block, development, campus, combination of buildings, project, building, residence, apartment or other structure or sub-structure.

14. The method of claim 11, wherein the subject area is not predetermined by the one or more processors and the one or more processors determine the subject area based on a generalized name for the subject area or other general location provided by a user on a use-by-use basis determined by one or both of an artificial intelligence and an algorithm using natural language and cognition processing.

15. The method of claim 11, wherein the input of the micro location identifiers by the user is based on at least one of text, voice, selection, brain communication interfaces, scanning, and hyperlink.

16. The method of claim 11, wherein the one or more processors use or include additional information, search results, or services related to the one or more micro-locations identified by the micro-location identifiers determined with reference to the subject area in response to any input or communication related to the one or more micro-location identifiers.

17. The method of claim 11, wherein, if determined to be appropriate by the one or more processors, the one or more processors disambiguate, or determine one or more of the one or more micro-location identifiers, the subject area, or the one or more processors select or determine the subject area by using information provided, known, or determinable by one of a sending or receiving electronic device or remote servers, including one of a) general location or other information related to the one or more of the micro-location identifiers or subject area, b) the identity of the user, and c) user and device generated contextual information related to one of the user, use, or general location or other information related to the user or use.

18. The method of claim 17, wherein the one or more processors are configured to display the micro-location identifier on digital maps, displays, aerial, satellite, and other images, drawings, floorplans, schematics in order to identify the subject micro-location identifier.

19. The method of claim 11, wherein each of the one or more micro location identifiers consists of one of a) one to ten numeric or alphanumeric characters organized and structured in a two-dimensional xy or three-dimensional xyz format; b) one to ten numeric or alphanumeric characters organized and structured in a hierarchical, nested format; c) one to ten numeric or alphanumeric randomized characters; or d) one to ten numeric or alphanumeric characterized organized and structured in a hybrid xy, xyz, hierarchical/nested, or random format.

20. The system of claim 11, wherein the micro-location identifier consists of one of: a) a pair of 1-meter and 10-meter least significant digits derived from the 1-meter Universal Transverse Mercator coordinate pairs for the micro-location, b) a pair of 1-meter, 10-meter, and 100-meter least significant digits derived from the 1-meter Universal Transverse Mercator coordinate pairs for the micro-location, c) a pair of 1-meter, 10-meter, 100-meter, and 1,000-meter least significant digits derived from the 1-meter Universal Transverse Mercator coordinate pairs for the micro-location, d) a pair of 1-meter, 10-meter, 100-meter, 1,000-meter, and 10,000-meter least significant digits derived from the 1-meter Universal Transverse Mercator coordinate pairs for the micro-location, and e) one of the foregoing automatically determined to be the least number of pairs required based on the distance of the micro-location from the anchor established by the reference subject area for the subject area.

21-22. (canceled)

23. A method for identifying and referencing one or more micro-locations with reference to a first location with two or more alphanumeric shortcode micro-location identifiers for human-to-human, human-to-device, and device-to-device identification, designation, communications, use, input, output and displays such that the variable number of digits displayed or used in the micro-location identifier are the minimum number of digits necessary to discretely identify the one or more micro-locations relative to the first location, the method comprising:
designating a desired level of precision;
displaying, on a display of an electronic device, a number of least significant digits with the designated level of precision of one of a two-dimensional xy or three-dimensional xyz coordinate system based on the distance from the first location such that the minimum number of digits displayed or used are the minimum number of digits necessary to discretely identify the one or more micro-locations with a designated level of precision based on the coordinate system and the distance from the first location;
enabling a user to enter, input, speak, see, or select, using an interface of the electronic device, one or more micro-location identifiers with reference to the first location; and
whereupon one or more processors resolve and use the micro-location identifiers.

24. (canceled)

25. The system of claim 1, wherein the system automatically determines the number of digits contained in the micro-location identifier based on a subject area and reference subject area and determined by reference to at least one of: a) displaying or using a portion of the least significant digits based on a pre-selected level of precision of a global allocentric two-dimensional coordinate system such as latitude and longitude, Universal Transverse Mercator, Military Grid Reference, or United States National Grid; b) displaying or using a portion of the least significant digits based on a pre-selected level of precision of a global allocentric three-dimensional coordinate system such as Earth-centered, Earth-fixed (ECEF) or the geocentric coordinate system; c) displaying or using a portion of the least significant digits of such coordinates based on a pre-selected level of precision of an egocentric two or three dimensional coordinate system based on the size of the subject area; d) assigning specific micro-location identifiers for one or more specific micro-locations with reference to the subject area; e) one of the foregoing encrypted in a manner that it cannot be used without an encryption key; f) random micro-location identifiers in a manner that it cannot be used without an encryption key; and g) a hybrid combination of the foregoing for the subject area and reference subject area.
